(19) United States
(12) Patent Application Publication
(10) Pub. No.: US 2013/0186761 A1
(43) Pub. Date: Jul. 25, 2013

(54) APPARATUS FOR REMOVAL OF IONS COMPRISING AN ION EXCHANGE MEMBRANE THAT COMPRISES A CROSSLINKED HYPERBRANCHED (CO)POLYMER (A CROSSLINKED HBP) WITH ION EXCHANGE GROUPS

(71) Applicants: Albert Van Der Wal, Oegstgeest (NL); Hank Robert Reinhoudt, Delft (NL); Henricus Marie Janssen, Eindhoven (NL); Michel Henri Chretien Joseph Van Houtem, Eindhoven (NL)

(72) Inventors: Albert Van Der Wal, Oegstgeest (NL); Hank Robert Reinhoudt, Delft (NL); Henricus Marie Janssen, Eindhoven (NL); Michel Henri Chretien Joseph Van Houtem, Eindhoven (NL)

(73) Assignee: VOLTEA B.V., Sassenheim (NL)

(21) Appl. No.: 13/822,793

(22) PCT Filed: Sep. 16, 2011
(86) PCT No.: PCT/NL11/50627

§ 371 Date: Apr. 12, 2013

(30) Foreign Application Priority Data
Sep. 16, 2010 (EP) 10177069.1

(51) Int. Cl. C02F 1/469

(52) U.S. Cl. CPC C02F 1/4691
USPC 204/554; 521/31; 521/33; 521/27; 204/665; 210/500.27

(57) ABSTRACT

An apparatus to remove ions, the apparatus including a housing, an inlet to let water into the housing, an outlet to let water out of the housing, a first electrode, a second electrode, a spacer between the first and second electrodes to allow water to flow between the first and second electrodes, and an ion exchange membrane between the first and/or second electrode and the spacer, wherein the membrane has a crosslinked hyperbranched polymer with ion exchange groups.

### FIELD

The invention relates to an apparatus to remove ions (e.g., to purify an aqueous solution), such an apparatus comprising an ion exchange membrane, an ion exchange membrane comprising a polymer and a method for preparing such a polymer.

### BACKGROUND

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionization, using an apparatus provided with a flow through capacitor (FTC) for removal of ions from water. The FTC functions as an electrically regenerable cell for capacitive deionization. By charging electrodes, ions are removed from an electrolyte and are held in electric double layers at the electrodes. The electrodes can be (partially) electrically regenerated to desorb such previously removed ions without requiring a chemical treatment.

An apparatus to remove ions generally comprises one or more pairs of spaced apart electrodes (a cathode and an anode) and a spacer, separating the electrodes and allowing water to flow between the electrodes. The apparatus has a housing comprising an inlet to let water into the housing and an outlet to let water out of the housing. In the housing, layers of the electrodes and spacers are stacked in a “sandwich” fashion by compressive force, normally by mechanical fastening.

A membrane may be placed adjacent to an electrode of a flow through capacitor. The term membrane may refer to a layer of material which is permeable or semi-permeable for ions and which is capable of retaining ions. A membrane may allow an increase in ion removal efficiency, which in turn may allow energy efficient ion removal from aqueous solutions.

A membrane may comprise ion exchange groups (see, e.g., PCT patent application publication no. WO 2009/062872). Ion exchange groups may provide a charge to the membrane. For example, when a cation exchange group is used, the membrane is negatively charged. The negative charge of the membrane may repel negative ions, while attracting positive ions, resulting in the membrane being selective for positively charged ions, i.e. cations. Alternatively, when an anion exchange group is used, the membrane is positively charged. The positive charge of the membrane may repel positive ions, while attracting negative ions, resulting in the membrane being selective for negatively charged ions, i.e. anions. Ion exchange membranes are therefore either selective for anions, or selective for cations.

### SUMMARY

A membrane may be sensitive to swelling when brought into contact with water, swelling may exert unwanted stress in the membrane layer(s) which can lead to curling or even delaminating and/or detachment of the membrane.

It is desirable, for example, to provide an apparatus to remove ions having an improved membrane. It is desirable, for example, to provide an improved membrane, and to provide for a method for preparing an improved membrane.

Hyperbranched (co)polymers, hereafter and herein also referred to as HBPs, are suitable for preparing a membrane, more in particular for preparing an ion exchange membrane. Hyperbranched (co)polymers can be crosslinked forming a crosslinked hyperbranched (co)polymer with ion exchange groups. A membrane comprising a crosslinked HBP with on exchange groups can be used in an apparatus to remove ions from water.

In an embodiment, there is provided an apparatus to remove ions, the apparatus comprising a membrane which comprises a crosslinked HBP with ion exchange groups. For example, there is provided an apparatus comprising a crosslinked HBP with ion exchange groups as described below. There is also provided an ion exchange membrane comprising a crosslinked HBP with ion exchange groups. There is also provided a method of preparing a crosslinked HBP with ion exchange groups.

### BRIEF DESCRIPTION OF THE FIGURES

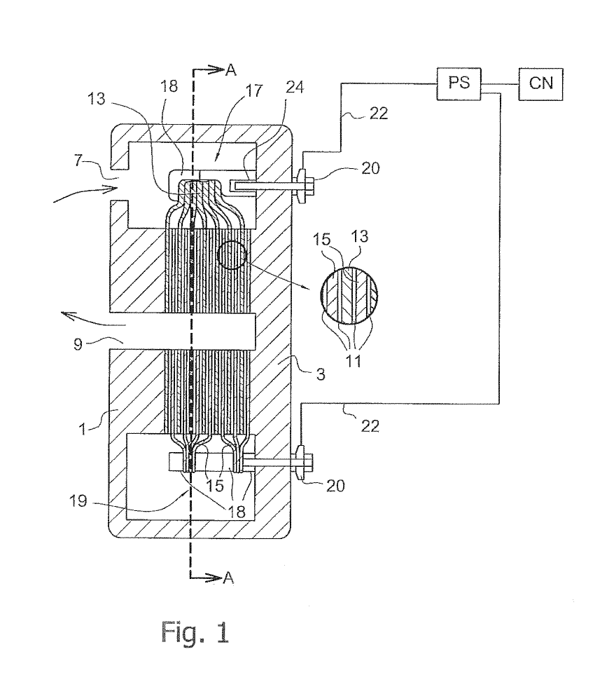

Embodiments of the invention will be described, by way of example only, with reference to the accompanying schematic drawings (FIGS. 1-3) in which corresponding reference symbols indicate corresponding parts of an apparatus to remove ions.

### DETAILED DESCRIPTION

### The Apparatus

In one aspect, an apparatus is provided to remove ions, the apparatus comprising:
a housing
an inlet to let water into the housing;
an outlet to let water out of the housing;
a first electrode and a second electrode in the housing;
a spacer between the first and second electrodes to allow water to flow in between the first and second electrodes; and
an ion exchange membrane between the first and/or second electrode and the spacer,

wherein the membrane comprises a crosslinked hyperbranched (co)polymer with ion exchange groups.

FIG. 1 shows a schematic cross-section of an apparatus to remove ions according to an embodiment. The apparatus may have a housing comprising a first housing part 1 and a second housing part 3 made of a relatively hard material e.g. a hard plastic. By pressing the first and second housing parts on each other, for example with a bolt and nut (not shown) the housing is made liquid tight. Adhesive, a seal or an O-ring may be used to improve the liquid tightness of the housing.

The housing has an inlet 7 and an outlet 9. During ion removal from the water, the water will flow from the inlet 7 to the outlet 9 through the spacer 11 which separates a first electrode 13 and a second electrode 15 from each other. The electrodes are clamped within the housing to provide a water leakage free apparatus. By creating an electrical potential difference between the first and second electrodes, for example by applying a positive voltage to the current collector of the first electrode (the anode) 13 and a negative voltage to the current collector of the second electrode (cathode) 15, the anions of the water flowing through the spacer 11 are attracted to the first electrode and the cations are attracted to the second electrode. In this way the ions (anions and cations) will be removed from the water flowing through the spacer 11. In between the electrodes and the spacer (i.e. between 11 and 13 and/or between 11 and 15), an ion exchange membrane according to an embodiment of the invention may be positioned.

If the electrodes are saturated with ions the electrodes may be regenerated by releasing the potential difference and electrically discharging the electrodes. This way the ions will be released from the electrodes into the water flowing through the spacer. This will result in an increase in the ion content in the water in the spacer and this water will be flushed out of the spacer. Once most ions are released from the electrodes and the water with increased ion content is flushed out of the spacer the electrodes are regenerated and can be used again for attracting ions.

The electrical potential difference between the anode and the cathode is rather low, for example lower than 2 volts, lower than 1.7 volts or lower than 1.4 volts. The electrical resistance of the electrical circuit should be sufficiently low. Therefore, ion exchange membranes that have a low electrical resistance should. At the same time, the membranes should desirably be cheap enough to make them cost effective. These membranes may preferentially be selective, for example, for anions or cations or for certain anion species or for certain cation species. In an embodiment, membranes described herein are to be used in a FTC device for improved desalination efficiency.

The electrodes to be used in the apparatus to remove ions may be substantially metal free to keep them corrosion free in the wet interior of the housing and at the same time cheap enough for mass production. The electrodes may be produced from a current collector 13, 15 provided with a substantially metal free electrically conductive high surface area layer, or self supporting film, which may contain activated carbon, carbon nanotubes or carbon aerogel on both sides which are in contact with the water. The electrode comprises a material to store ions, for example a high surface area layer which is a layer with a high surface area in square meters per weight of layer material e.g. >500 m²/gr.

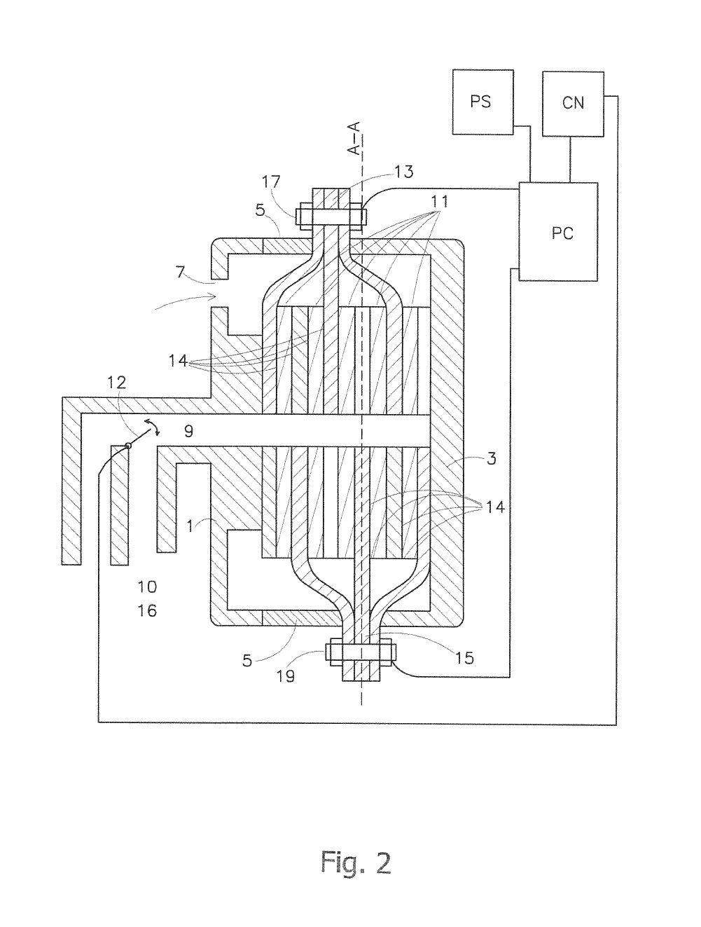

FIG. 2 shows a schematic cross-section of an apparatus to remove ions according to an embodiment of the invention. The apparatus has a housing comprising a first housing part 1 and a second housing part 3 made of a relatively hard material e.g. a hard plastic. A third housing part 5 is made of a relatively soft material e.g. rubber, filler or glue. By pressing the first, second and third housing parts on each other, for example with a bolt and nut (not shown) the housing is made liquid tight.

The housing has an inlet 7 and an outlet 9. During ion removal, the water will flow from the inlet 7 to the outlet 9 through the spacer 11 which separates a first electrode 13 and a second electrode 15 of a flow through capacitor (FTC) from each other. The electrodes are clamped within the housing to provide a substantially liquid leakage free apparatus. By creating an electrical potential difference between the first and second electrodes by a power converter PC, for example by connecting a positive voltage to the first electrode (the anode) 13 and a negative voltage to the second electrode (cathode) 15, the anions of the water flowing through the spacer 11 are attracted to the first electrode and the cations are attracted to the second electrode. In this way the ions (anions and cations) will be removed from the water flowing through the spacer 11. The purified water may be discharged to the purified water outlet 10 by the valve 12. If the surface of the electrodes is saturated with ions the electrodes may be regenerated by reducing or even reversing the potential difference. This will release the ions in the water flowing through the spacer. This will increase the ion content in the water and this water will be flushed away by closing the purified water outlet 10 with a valve 12 under control of the controller CN and opening the waste water outlet 16. Once most ions are released from the electrodes and the water with increased ion content is flushed away via the waste water outlet 16 the electrodes are regenerated and can be used again for attracting ions.

The electrical potential difference between the anode and the cathode is rather low, for example lower than 2 volts, lower than 1.7 volts or lower than 1.4 volts. A power converter PC under control of the controller CN is used to convert the power from the power source PS to the correct electrical potential. The electrical resistance of the electrical circuit should be low. For this purpose, different parts of the first electrode 13 are connected to each other with the first connector 17 and different parts of the second electrode 15 are connected to each other with the second connector 19. The electrodes 13, 15 may be made substantially metal free to keep them corrosion free in the wet interior of the housing and at the same time cheap enough for mass production. The electrodes 13, 15 may be produced from a current collector provided with a substantially metal free electrically conductive high surface area layer, or self-supporting film, which may contain activated carbon or carbon aerogel on both sides which are in contact with the water. A high surface area layer is a layer with a high surface area in square meter per weight of layer material.

A membrane 14 may be positioned in between the first and/or second electrode and the spacer. The membrane may be less than 200 micrometers, less than 100 micrometers, or less than 60 micrometers thick.

Membrane 14 may comprise a crosslinked hyperbranched (co)polymer with ion exchange groups.

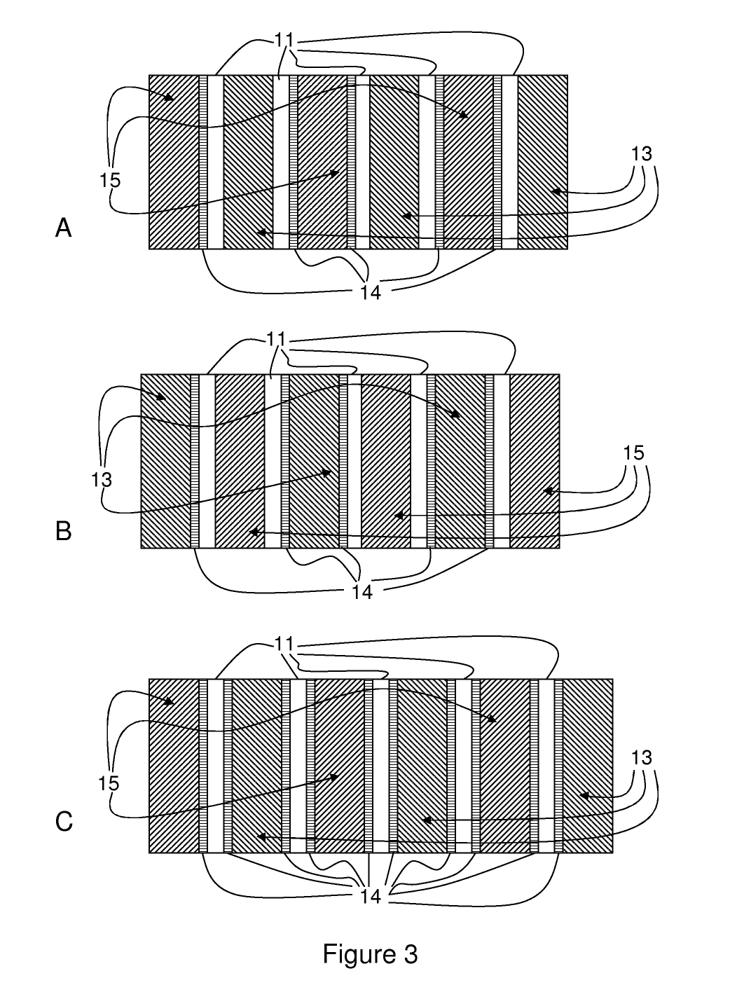

FIG. 3 shows schematics of stacking of electrodes, spacers and membranes. The first (13) and second (15) electrodes are stacked with a spacer (11) and an ion exchange membrane (14) comprising a crosslinked hyperbranched (co)polymer with ion exchange groups. In FIG. 3(A), the ion exchange membrane (14) is positioned between the second electrode (15) and the spacer (11). In FIG. 3(B), the ion exchange membrane (14) is positioned between the first electrode (13) and the spacer (11). In FIG. 3(C), the ion exchange membrane (14) is positioned between the first electrode (13) and the spacer (11) and between the second electrode (15) and the spacer (11).

A Method of Preparation of an Ion Exchange Membrane Comprising a Crosslinked Hyperbranched (Co)Polymer with Ion Exchange Groups

In an aspect of the invention, a method is provided for preparing a crosslinked hyperbranched (co)polymer with ion exchange groups, the method comprising:
providing a hyperbranched (co)polymer,
providing a crosslinker,
crosslinking the hyperbranched (co)polymer with the crosslinker;
wherein the crosslinker and/or the hyperbranched (co)polymer comprises an ion exchange group, and/or wherein during the crosslinking, an ion exchange group is formed. The ion exchange group may be a cation exchange group or an anion exchange group.

### The Hyperbranched (Co)Polymer

According to an embodiment, the provided hyperbranched (co)polymer (HBP) may be prepared by any method known in the art in the past, present or future. Methods for preparing HBPs have been described, e.g. as reviewed by Gao and Yan, Prog. Polym. Sci., 29, 2004, 183-275 and by Voit and Lederer, Chem. Rev. 2009, 109, 5924-5973. Hyperbranched (co)polymers are a subclass of a class of macromolecules called dendritic polymers. As the name implies, hyperbranched (or dendritic) (co)polymers have a high degree of branching. Furthermore, they can have a high density of functional groups, small size, and/or low dispersity. The class of dendritic polymers can be divided in subclasses, namely: dendrimers, dendrigrafts and hyperbranched (co)polymers. Dendrimers are artificial macromolecules, which are synthesized through a step-wise process. On the other end of the spectrum are hyperbranched (co)polymers which are generally produced in a one-step process. When the term hyperbranched (co)polymers or HBP is used, it may encompass the entire class of dendritic polymers. Hyperbranched (co)polymers, however, are desirable, because of their one step preparation.

As an HBP is in general produced in a one-step process, the branching of the HBP may be less well or not controlled and may be of random nature. Hence, when a HBP is prepared, it is in general not homogeneous, i.e. comprising a collection of identical HBP molecules, but it comprises a heterogeneous population of HBP molecules. Hence, when the term a hyperbranched (co)polymer or HBP is used, it may comprise such a heterogeneous collection of hyperbranched (co)polymer molecules. The term HBP may also comprise a mixture of at least two different hyperbranched (co)polymers (differing by their method of preparation and/or composition), which at least two differently prepared hyperbranched (co)polymers by themselves may be heterogeneous.

The term HBP may refer to an HBP molecule. As used herein, the singular forms, e.g. “a,” “an” and “the” may include plural referents, unless the context clearly dictates otherwise. For example, a method for preparing “a” HBP, as used herein, includes preparing the plurality of HBP molecules (e.g. 10's, 100's, 1000's, 10's of thousands, 100's of thousands, millions, or more molecules). In addition, “providing a crosslinker”, as used herein, includes providing a plurality of molecules (e.g. 10's, 100's, 1000's, 10's of thousands, 100's of thousands, millions, or more molecules).

As HBPs may be heterogeneous, a HBP may be defined by its method of preparation (see below), as the polymerization is a statistical process defined by the reaction conditions, e.g. molar amounts and/or ratios of reactants used for the preparation of a HBP. Alternatively or additionally, a HBP may be defined by a particular size range, an average degree of branching, the average degree of functionalization with ion exchange groups and/or degree of functionalization with complementary reactive groups. Thus, when the term hyperbranched (co)polymer or HBP is used, it may include such a heterogeneous population.

The hyperbranched (co)polymer according to an embodiment has a number average molecular weight (Mn) in the range of 250 Dalton to 100,000 Dalton, from 500 Dalton to 50,000 Dalton, from 750 Dalton to 25,000 Dalton, or a molecular weight of 1000 Dalton to 10,000 Dalton. The molecular weight distribution or dispersity D, or polydispersity index PDI is calculated by dividing the weight average molecular weight by the number average molecular weight: D=PDI=Mw/Mn. The PDI of a HBP is, in an embodiment, from 1.0 (for a single molecule) to 15, from 1.5 to 12 or from 2 to 6. These PDI index ranges represent molecular weight distributions that are regarded as relatively broad or polydisperse. Both the weight average molar mass and the number average molar mass of a HBP can be determined by using e.g. gel permeation chromatography (GPC), also known as size exclusion chromatography (SEC), using reference polymer standards, such as polystyrene (PS) standards or polyethylene oxide (PEO) standards.

In general, a hyperbranched (co)polymer may be prepared from at least a branching monomer (see below for a more detailed description on the preparation of HBPs). In addition to a branching monomer, also co-monomers may be used. A branching monomer is a monomer that after polymerization may have led to a branching point, so that the polymer molecule at this branching point can grow in three or more directions. A branching monomer may therefore be defined as a molecule that can grow, i.e. polymerize, in at least three directions during the polymerization reaction. Thus, a branching monomer, can react at at least three different positions during polymerization, resulting in chain growth at at least three different positions. Co-monomers are not branching monomers, and can react with the branching monomer in the polymerization reaction. A co-monomer may grow in the polymerization reaction in two directions, reacting with another co-monomer or branching monomer. Furthermore, a chain transfer agent may be used in the polymerization which may terminate polymerization at a particular position, which may control the growth of HBPs during the polymerization reaction. In the preparation of HBP, the chemistry, the reactants and/or the set of monomers is desirably chosen such that HBP molecules during the polymerization reaction may be prevented from reacting with each other, preventing crosslinking. This way, gelation may be prevented. The HBP formed may be soluble.

The (average) extent of branching or degree of branching of hyperbranched polymers has been defined in literature in various and different definitions (see e.g. Voit and Lederer, Chem. Rev. 2009, 109, 5924-5973, O'Brien, Polymer, 41, 2000, 6027-6031). Most of these definitions use the fractions of units at the termini, branching units and linear units in a material to determine the degree of branching. However, this may be often difficult, if not impossible, to reliably assess experimentally for many HBPs. An alternative way to define the degree of branching is by the relative amount of a branching monomer(s) used in the preparation of a HBP, and by the extent of incorporation of a branching monomer(s) into a HBP.

In one embodiment, the branching monomer(s) is used in excess of 0.5% mol/mol %, in excess of 2 mol/mol %, in excess of 5 mol/mol % or in excess of 7 mol/mol %. These percentages are relative with regard to the reactants used, i.e. branching monomer, co-monomer, and/or chain transfer agent. Also, the amount of branching monomer used may be, in an embodiment, less than 50 mol/mol %, less than 40 mol/mol %, or less than 25 mol/mol %. These molar percentages can be calculated from the used molar amounts of reactants.

The HBP may comprise in excess of 2 mol/mol %, in excess of 4 mol/mol %, in excess of 7 mol/mol % or in excess of 10 mol/mol %, of branching monomer. These percentages are relative to all reactants (i.e. branching monomer, co-monomer, and/or chain transfer agent). These molar percentages of incorporated branching monomer(s) can be derived from experimental data, for example from ¹H NMR spectra that can be recorded from an HBP. Usually, the different monomers and reactants that are incorporated into the HBP have characteristic resonances in ¹H NMR, and from the integrations of these signals quantitative data can be derived, such as the molar ratios of incorporated monomers and reactants (see example section). A HBP may comprise, on average at least 0.2 branching monomer unit per molecule HBP, at least 1 branching monomer unit, at least 2 branching monomer units, or at least 3 branching monomer units. These numbers can be derived from combined ¹H NMR spectral data and number average molecular weight (Mn) data. Also, on average at least 1 branching monomer unit may be incorporated per HBP-molecule, at least 2 branching monomer units, at least 4 branching monomer units, or at least 6 branching monomer units. These data can be estimated from combined ¹H NMR and weight average molecular weight (Mw) data. The Mn and Mw data can be determined by for example GPC measurements, where these data are relative to those of PS or PEO standards.

A HBP may be amorphous or may be semi-crystalline. However, due to the heterogeneity and irregular molecular structures in HBP materials, the HBP is usually amorphous. Crystallization processes that may occur over time may influence the performance of an ion exchange membrane negatively, for example because crystallization may result in stresses that cause cracking of a membrane material. An amorphous HBP may therefore be desired. A HBP may have a Tg ranging from −60° C. to 180° C., from −40° C. to 135° C., from −20° C. to 90° C., or from 0° C. to 70° C., where the Tg can be recorded experimentally with differential scanning calorimetry (DSC) as shown in the examples.

In an embodiment, the HBP is a methacrylate based HBP or an acrylamide based HBP.

### The Crosslinker and the HBP

For the preparation of the crosslinked HBP with ion exchange groups, at least a HBP and a crosslinker is provided. The crosslinker according to an embodiment may comprise (on average) two reactive groups, although three or more reactive groups are possible. The HBP according to an embodiment has reactive groups that enable reaction, forming a covalent bond, with the crosslinker. The average number of these reactive groups per HBP-molecule is at least 2, at least 4, at least 6 or at least 10. An average number of reactive groups per HBP-molecule may also further describe the HBP as a HBP usually represents a heterogeneous mixture of macromolecules.

Control over properties and performance of the crosslinked HBP with ion exchange groups may be exerted by choosing the proper ratio between the HBP and crosslinker, as this may determine the molar equivalence between the reactive groups on the HBP and crosslinker. The level of crosslinking can thus be controlled, as well as the concentration of the ion exchange groups in the crosslinked hyperbranched (co)polymer with ion exchange groups. The crosslinking reaction may be performed with the aid of one or more solvents (e.g. alcohol or non-protic solvent), reagents (e.g. non-nucleophilic base such as diisopropylethyl amine), activating agents (e.g. carbodiimide agent in reactions between acid and an amine reactive group) and/or catalysts (e.g. metal catalyst in reactions between alcohol and isocyanate). The reaction conditions may also be varied with regard to temperature, performing the reaction under inert gas such as argon or nitrogen, and/or using a light source as a reaction initiator or stimulus.

The reactive groups of the crosslinker may react with reactive groups present in the HBP. Thus, when a reactive group of a crosslinker molecule reacts with a reactive group on a HBP molecule, the crosslinker molecule is covalently bound with the HBP molecule. When another reactive group of the crosslinker reacts with another HBP molecule, forming a covalent bond with the other HBP molecule, the crosslinker has formed a crosslink between two HBP molecules. Hence, when between HBP molecules crosslinks are formed, a crosslinked HBP is formed. HBPs may have a large number of reactive groups such that multiple crosslinks between HBPs may occur, and a network of crosslinked HBPs is formed. The crosslinked HBP with ion exchange groups thus formed, may have gel like or solid like properties. The reactive groups of the crosslinker and HBP may be complementary, such that crosslinkers may not react with each other, and/or HBPs may not react with each other, such that a crosslinker desirably reacts with a HBP. As HBPs have a large number of reactive groups, multiple crosslinks between HBP-molecules may be formed, so that the crosslinker has enabled the formation of a covalently connected network of HBP molecules.

It is possible that to some extent a reactive group of a crosslinker molecule may react with a reactive group on a HBP-molecule, while another reactive group of the same crosslinker molecule may react with a second reactive group of the same HBP-molecule, thus forming a covalent connection within one HBP-molecule that does not contribute to network formation between HBP molecules. Such intramolecular reactions, i.e. reactions within a single HBP molecule, may be controlled by the varying the concentrations of reactants. Performing the crosslinking process at high concentrations of HBP molecules may favor the crosslinking process between HBP molecules, as the chance of an intermolecular reaction between HBP molecules and a crosslinker molecule will increase. Performing the reaction at dilute concentrations using a high amount of solvent will increase the occurrence of the intramolecular reactions, as the chance of intermolecular reactions between HBP molecules, of which one already has reacted with a crosslinking molecule is reduced, and an intramolecular crosslink may be favored. It is therefore desirable to do the crosslinking step at high concentrations of the HBP, using little solvent, as this may be favorable for efficient crosslinking. As HBPs may be very well dissolvable, the use of a HBP in particular may allow for selection of such conditions. In contrast, other polymers, e.g. linear (co)polymers are much less soluble, thus reactions are carried out in less favorable conditions with regard to intermolecular crosslinking. When such polymers are crosslinked, intramolecular crosslinks may more often be formed.

Properties of HBPs, such as high solubility, low solution and melt viscosities and/or high number of reactive groups per molecule, thus may allow for an easy and efficient crosslinking step that can result in dense concentrations of ion exchange groups in the crosslinked HBP with ion exchange groups. Not much solvent may be needed to dissolve large quantities of HBP, the solution can still have low viscosity which may make it easily to handle. The crosslinking step may run smoothly and to high conversions, first in solution when there may be a high concentration in reactive groups, and after the solvent has evaporated in the bulk, viscosities can remain relatively low enhancing the diffusion of reactants.

The crosslinker or the HBP may comprise an ion exchange group, such that when the HBP and crosslinker are reacted a crosslinked HBP with ion exchange groups is formed. In a particular embodiment, a HBP may have reactive groups that are ion exchange groups such as e.g. carboxylate or sulfonate groups, which groups may be converted to amide or sulfonamide linkages by reaction with amine groups in a crosslinker. In the preparation of the crosslinked HBP with ion exchange groups, a portion of the carboxylate or sulfonate ion exchange groups of the HBP is not reacted with the crosslinker, so that a portion of the carboxylate or sulfonate ion exchange groups is retained. This way, a crosslinked HBP with ion exchange groups may be formed.

As long as a crosslinker and a HBP have complementary reactive groups, i.e. they can react with each other forming crosslinks, such a crosslinker and HBP may be used. Thus, the complementary reactive groups in the crosslinker and the HBP may be any combination of two reactive groups that effectively leads to a covalent bond formation between the crosslinker and HBP. For example, one may have alcohol reactive groups, while the other may have carboxylic acid, carboxylic (activated) ester or anhydride reactive groups to enable the formation of ester linkages; the other may have isocyanate reactive groups thus forming urethane linkages; the other may have halide, tosylate, mesylate or triflate reactive groups thus forming ether linkages. Furthermore, one may comprise primary amine or secondary amine reactive groups, while the other may have isocyanate reactive groups (to form urea linkages), carboxylic acid, carboxylic (activated) ester or (cyclic) anhydride reactive groups (to form amide linkages), ethylenenically monounsaturated reactive groups such as (meth)acrylates, (meth)acryl amides or vinyl derived groups (to form amine linkages in Michael-type of additions), epoxide reactive groups (to form an amine alcohol linkage), sulfonate or activated sulfonate reactive groups (to form sulfon amide linkages), or halide, tosylate, mesylate or triflate reactive groups (to form secondary or tertiary amine linkages). Alternatively, one may comprise tertiary amine, pyridine or tertiary phosphine reactive groups, while the other may have halide, tosylate, mesylate or triflate reactive groups, upon crosslinking, quaternary ammonium, pyridinium or quaternary phosphonium crosslinkes may be formed.

Accordingly, examples of crosslinkers are diamines, dihalides, ditosylates, dimesylates, diols, dicarboxylic acids, di-activated esters, di-vinyl compounds, dianhydrides, particularly di cyclic anhydrides, di-isocyanates and di-epoxides. Crosslinkers that may be desirable are di-cyclic anhydrides, diamines, dipyridines or dihalides. For amine groups in the crosslinker, either primary or secondary amines can be used, which are reactive towards e.g. carboxylic acids and its derivatives or towards sulfonates and its derivatives. Tertiary amines can also be used and are desirable as these can generate ion exchange groups upon reaction with e.g. halides. In case halides are used, the more reactive halides are desirable, such as activated halides (e.g. benzyl chlorides), bromides or iodides. Crosslinker molecules may be, for example, di-cyclic anhydrides such as pyromellitic dianhydride, EDTA-dianhydride, DTPA-dianhydride, benzophenone-3,3′,4,4′-tetracarboxylic dianhydride, di primary amines such as diaminobutane and diaminohexane, di secondary amines such as piperazine and N,N′-dimethyl alkanediamines, di tertiary amines such as tetramethyl alkanediamines, dipyridines such as 4,4′-bipyridine, or dihalides such as 1,6-diiodohexane, 1,6-dibromohexane, 1,10-dibromodecane.

In an embodiment of the method for preparing the crosslinked hyperbranched (co)polymer with ion exchange groups, an ion exchange group is formed during the crosslinking step. Desirably, the hyperbranched (co)polymer and crosslinker comprise reactive groups that are capable of reacting with each other form a covalent bond and an ion exchange group. The ion exchange group that is formed may be a cation exchange group or an anion exchange group.

When the ion exchange group is an anion exchange group, the reactive group of the hyperbranched (co)polymer is desirably a tertiary amine, a pyridine, a guanidine and/or a phosphine group and the reactive group of the crosslinker may be a halide, tosylate, mesylate or triflate group, or the reactive group of the crosslinker is desirably a tertiary amine, a pyridine, a guanidine and/or a phosphine group and the reactive group of the hyperbranched (co)polymer may be a halide, tosylate, mesylate or triflate group. Thus quaternary ammonium, pyridinium, guanidinium or phosphonium anion exchange groups may be created, respectively, when the HBP and the crosslinker have reacted.

When the ion exchange group is a cation exchange group, the reactive group of the hyperbranched (co)polymer is desirably a primary or secondary amine group, and the reactive group of the crosslinker a cyclic anhydride, or the reactive group of the hyperbranched (co)polymer is desirably a cyclic anhydride, and the reactive group of the crosslinker may be a primary or secondary amine group. This way, carboxylate cation exchange groups may be formed upon the formation of the amide linkage between the HBP and crosslinker.

The reaction of the HBP with the crosslinker may result in the formation of an ion exchange group, while simultaneously crosslinking the HBPs, thus preparing a crosslinked hyperbranched (co)polymer with ion exchange groups. In addition, or alternatively, the HBP and/or the crosslinker may already comprise ion exchange groups. With comprising ion exchange groups, it is meant, according to an embodiment, that the ion exchange groups are covalently bound to the HBP, crosslinker and/or crosslinked HBP. Alternatively or alternatively, ion exchange groups may be covalenty bound to a crosslinked hyperbranched (co)polymer already prepared, forming a crosslinked hyperbranched (co)polymer with ion exchange groups, although this may be less desired as it would involve an extra step. In any of those cases, a crosslinked hyperbranched (co)polymer with ion exchange groups is prepared. As long as a crosslinked hyperbranched (co)polymer with ion exchange groups is prepared or provided, such a crosslinked hyperbranched (co)polymer with ion exchange groups may be used in an embodiment of the invention.

In an embodiment, the crosslinker and/or hyperbranched (co)polymer may comprise hydrophilic groups and hydrophobic groups. Providing such groups may affect the reaction conditions (e.g. solvents, reaction kinetics) during the crosslinking step and/or the properties of the crosslinked hyperbranched (co)polymer with ion exchange groups.

Ion Exchange Group Formation or Activation without Crosslinking the HBP

Formation of ion exchange groups may be performed without crosslinking the HBP. This way the level of crosslinking between and within the HBPs may be reduced. The ion exchange capacity of the membrane may not be reduced. The ion exchange capacity may also be increased without increasing crosslinking. An advantage of a lower level of crosslinking may be that the membrane becomes less electrically resistant to ion transport. This in turn may improve the desalination performance of the FTC system.

The formation or activation of ion exchange groups can be performed by using a group activator, A group activator is a compound that can react with the HBP, e.g. with a nitrogen atom or group at the polymer, which leads to a charged group in the HBP polymer. The group activator may comprise one reactive group, which is capable of reacting with the HBP. The HBP may have multiple groups that can react with the group activator and form a covalent bond. The average number of these reactive groups per HBP molecule is at least 2, at least 4, at least 6 or at least 10. An average number of reactive groups per HBP may also further describe the HBP as a HBP usually has a heterogeneous mixture of macromolecules. In an embodiment, the reactive groups of the HBP that may react with a group activator are the same reactive groups that may react with a crosslinker. The reactive group of the group activator may be the same reactive group of the crosslinker that can react with the HBP. The reactive group of the group activator may be different from the reactive group of the crosslinker, as long as both can react with the reactive groups of the HBP such different reactive groups for both the crosslinker and group activator may be contemplated.

Control over properties and performance of the crosslinked HBP with ion exchange groups may be exerted by choosing the proper ratio between the HBP, group activator and crosslinker, as this may determine the molar equivalence between the reactive groups on the HBP, group activator and crosslinker. The molar ratio between the group activator and the crosslinker may be any number from 3:1 or even higher or be as low as 1:3 or even lower. The group activator may be reacted with the HBP before, during or after the crosslinking step.

In one embodiment, the crosslinking step is performed with a limited amount of crosslinker such that not all the reactive groups of the HBP available for crosslinking have reacted. In a post-crosslinking step, the reactive groups of the crosslinked HBP may be subjected to a reaction with a group activator such that remaining reactive groups of the HBP react with the group activator.

In one embodiment, the crosslinking step is performed in the presence of both a crosslinker and a group activator. The ratio between the crosslinker and the group activator thus control the extent of crosslinking. Having a relatively low amount of crosslinker will result in a lower extent of crosslinking. It is understood that not only the ratio of crosslinker and group activator may determine the extent of crosslinking, the reactivity of the crosslinker and group activator, for example, may also determine the extent of crosslinking. The molar ratio between the group activator and crosslinker may range from 1:100 to 100:1. The molar ratio between the group activator and the crosslinker may range from 20:1 to 1:20. The molar ratio between the group activator and the crosslinker may be 3:1 or higher. The molar ratio between the group activator and the crosslinker may be 1:3 or lower. It is understood that as long as the amount of crosslinker in the reaction mixture comprising the crosslinker and the group activator is sufficient to substantially crosslink the HBP, such a ratio may be selected in this embodiment.

In one embodiment, prior to the crosslinking step the HBP is reacted with a group activator. The amount of group activator is such that at least 2 reactive groups or at least 3 reactive groups remain on average per HBP for the subsequent crosslinking step.

Reaction conditions for reacting a group activator (prior, during or after crosslinking) with a HBP may be selected that are highly similar to the reaction conditions for performing a crosslinking step.

The degree of crosslinking can thus be controlled, as well as the level of ion exchange groups in the crosslinked hyperbranched (co)polymer. The group activation reaction may be performed with the aid of one or more solvents (e.g. alcohol or non-protic solvent), reagents (e.g. non-nucleophilic base such as diisopropylethyl amine), activating agents (e.g. carbodiimide agent in reactions between acid and an amine reactive group) and/or catalysts (e.g. metal catalyst in reactions between alcohol and isocyanate). The reaction conditions may also be varied with regard to temperature, performing the reaction under inert gas such as argon or nitrogen, and/or using a light source as a reaction initiator or stimulus.

The reactive group of the group activator may react with reactive groups present in the HBP. Thus, when one of the reactive groups of a group activator molecule reacts with a reactive group on a HBP molecule, the group activator molecule may be covalently bound with the HBP molecule. Hence, the ion exchange group is formed without crosslinking of the HBP. The reactive groups of the group activator and HBP may be complementary, such that group activators may not react with each other and may not react with the crosslinker, while HBPs may not react with each other, such that a group activator may react exclusively with a HBP.

The group activator or the HBP may comprise an ion exchange group, such that when the HBP and the group activator are reacted a HBP with ion exchange groups is formed. In a particular embodiment, a HBP may have reactive groups that are ion exchange groups such as e.g. carboxylate or sulfonate groups, which groups may be converted to amide or sulfonamide linkages by reaction with amine groups in a group activator.

As long as a group activator and a HBP have complementary reactive groups, i.e. they can react with each other forming active ion exchange group, such a group activator and HBP may be used. Thus, the complementary reactive groups in the group activator and the HBP may be any combination of two reactive groups that effectively leads to a covalent bond formation between the group activator and HBP. For example, one may have alcohol reactive groups, while the other may have carboxylic acid, carboxylic (activated) ester or anhydride reactive groups to enable the formation of ester linkages; the other may have isocyanate reactive groups thus forming urethane linkages; the other may have halide, tosylate, mesylate or triflate reactive groups thus forming ether linkages. Furthermore, one of the reaction components (HBP or group activator) may comprise primary amine or secondary amine reactive groups, while the other reaction component may have isocyanate reactive groups (to form urea linkages), carboxylic acid, carboxylic (activated) ester or (cyclic) anhydride reactive groups (to form amide linkages), ethylenenically monounsaturated reactive groups such as (meth)acrylates, (meth)acryl amides or vinyl derived groups (to form amine linkages in Michael-type of additions), epoxide reactive groups (to form an amine alcohol linkage), sulfonate or activated sulfonate reactive groups (to form sulfon amide linkages), or halide, tosylate, mesylate or triflate reactive groups (to form secondary or tertiary amine linkages). Alternatively, one may comprise tertiary amine, pyridine or tertiary phosphine reactive groups, while the other may have halide, tosylate, mesylate or triflate reactive groups, upon group activation, quaternary ammonium, pyridinium or quaternary phosphonium linkages may be formed.

Accordingly, examples of group activators are monoamines, monohalides, monotosylates, monomesylates, alcohols, carboxylic acids, activated esters, monovinyl compounds, monoisocyanates and epoxides. Group activators that may be desirable are monoamines, monopyridines and monohalides. For amine groups in the group activator, either primary or secondary amines can be used, which are reactive towards e.g. carboxylic acids and its derivatives or towards sulfonates and its derivatives. Tertiary amines can also be used and are desirable as these can generate ion exchange groups upon reaction with e.g. monohalides. In case halides are used, the more reactive halides are desirable, such as activated halides, bromides and iodides. Group activator molecules may be, for example, primary amines; secondary amines such as methyl alkaneamines, tertiary amines such as tetramethyl alkaneamines, pyridines, monohalides such as alkyl or benzyl halides such as methyl halides, and/or ethyl halides.

In an embodiment of the method for preparing the hyperbranched (co)polymer with ion exchange groups, an ion exchange group is formed during the group activation step. In an embodiment, the hyperbranched (co)polymer and group activator comprise reactive groups that are capable of reacting with each other form a covalent bond and an ion exchange group. The ion exchange group that is formed may be a cation exchange group or an anion exchange group.

When the ion exchange group is an anion exchange group, the reactive group of the hyperbranched (co)polymer is desirably a tertiary amine, a pyridine, a guanidine and/or a phosphine group and the reactive group of the group activator may be a halide, tosylate, mesylate or triflate group, or the reactive group of the group activator is desirably a tertiary amine, a pyridine, a guanidine and/or a phosphine group and the reactive group of the hyperbranched (co)polymer may be a halide, tosylate, mesylate or triflate group. Thus quaternary ammonium, pyridinium, guanidinium or phosphonium anion exchange groups may be created, respectively, when the HBP and the group activator have reacted.

The reaction of the HBP with the group activator may result in the formation of an ion exchange group. In addition, or alternatively, the HBP and/or the group activator may already comprise at least one ion exchange group. With comprising ion exchange groups, it is meant, according to an embodiment, that the ion exchange groups are covalently bound to the HBP, group activator, crosslinker and/or crosslinked HBP. Alternatively or additionally, ion exchange groups may be covalenty bound to a crosslinked hyperbranched (co)polymer already prepared, forming a crosslinked hyperbranched (co)polymer with ion exchange groups. As long as a crosslinked hyperbranched (co)polymer with ion exchange groups is prepared or provided, such a crosslinked hyperbranched (co)polymer with ion exchange groups may be used in an embodiment.

In an embodiment, the group activator and/or hyperbranched (co)polymer may comprise hydrophilic groups and/or hydrophobic groups. Providing such groups may affect the reaction conditions (e.g. solvents, reaction kinetics) during the crosslinking step and/or the properties of the crosslinked hyperbranched (co)polymer with ion exchange groups.

### The Ion Exchange Groups

The ion exchange groups may be dissociable depending on the pH, but are desirably not pH-dependent, i.e. they do not change their charge upon pH-changes. Alternatively, the ion exchange groups may not be pH-dependent over a broad pH-range, for example from pH 5 to 9, from 3 to 11, from 2 to 12, or from 1 to 13 or even beyond. Ion exchange groups may either be anion exchange groups or cation exchange groups.

Anion exchange groups are positively charged and may be based on nitrogen or phosphor atoms that desirably do not bear any hydrogen atoms. Examples of anion exchange groups are quaternary ammonium charges (NR₄), quaternary phosphonium charges (PR₄), guanidinium charges, pyridinium charges or charges formed from nitrogen containing heterocycles other than pyridine, such as for example imidazoles, triazoles or oxazoles. The so-called strongly basic ion exchange groups (e.g. quaternary ammonium groups) are desirable over weakly basic groups (e.g. secondary or tertiary amines).

The cation exchange groups are negatively charged and may be based on sulfur, phosphor, boron or carbon atoms. Examples are sulfonate (R—SO₃⁻), phosphonate (R—PO₃²⁻), boronate (R—BO₂²⁻) or carboxylate (R—COO⁻) charges, wherein R may represent the crosslinker and/or HBP, or the crosslinked hyperbranched (co)polymer. Desirable negatively charged groups are sulfonate groups. In addition, so-called strongly acidic ion exchange groups (e.g. sulfonate groups) are desirable over weakly acidic groups (e.g. carboxylate groups).

### The Preparation of the Hyperbranched (Co)Polymer

HBPs may be prepared by step-growth methods or by chain-growth methods. In a typical step-growth method an ABₓ branching monomer is polycondensed (dependent on the availability of suitable monomers; usually x=2, where x represents the number of functional groups B in the monomer), where the functional groups A react with B, and not with other A groups. The B groups also do not react with each other, and have an equal or similar reactivity towards A. Side reactions are prevented or are insignificant. The result is a HBP with a high functionality in B-groups. A number of variations and modifications of a step-growth method are possible. For example, in addition to the ABₓ monomer, a multifunctional B_{y} monomer (where y represents the number of functional groups B in the monomer), an AB monomer, or a monomer with only one A-group may be used. In other frequently used methods, the multifunctional monomers A₂ and B_{y} are combined to produce an HBP material. Here, in principle, crosslinking may occur, but by controlling the conversion of the polymerization, undesired gelation may be prevented. Another way to circumvent crosslinking in the reaction between A₂ and B_{y} monomers is that one of the B-groups has a much higher reactivity towards the A-group (and therefore is in fact a C-group), so that an ABₓ monomer is formed in-situ. Step-growth methods have also been described by the way in which the branching monomer is used or applied (see Gao and Yan, Prog. Polym. Sci., 29, 2004), discriminating between single monomer methodologies (SMM), double monomer methodologies (DMM) and couple-monomer methodologies (CMM), where in the latter case the ABₓ branching monomer is formed in situ.

Step-growth methods are usually polycondensation reactions, leading to polyesters, polyamides, polycarbonates, polyureas, polyurethanes, polyethers or polyarylenes, but Michael-type of additions, i.e. additions where a primary or secondary amine adds to a double bond (leading to polyamines), or additions of alcohols to isocyanates (leading to polyurethanes) are also possible.

Chain growth methods that may be used to prepare HBPs are radical addition polymerization reactions, ring opening reactions, or anionic or cationic (living) polymerizations. The radical addition polymerizations may be free radical polymerizations, or controlled radical polymerizations, such as nitroxide-mediated radical polymerization (NMRP), atom-transfer radical polymerization (ATRP) or reversible addition-fragmentation chain transfer polymerizations (RAFT). Other controlled chain-growth processes that may be used are group-transfer polymerizations, ruthenium-catalyzed co-ordinative polymerizations or ring opening metathesis polymerizations (ROMP).

A chain-growth method to prepare HBPs may be according to the so-called self-condensing vinyl polymerization (SCVP), wherein an AB* branching monomer, in which A is a vinylic group that is capable of chain-growth vinyl-polymerization and B* is a group that potentially generates initiating sites for this vinyl-polymerization, providing the third direction in which the polymer chain may grow. The AB* branching monomer may be combined with an A monomer, so that not every monomeric unit is a potential branching unit. Similarly, in the self-condensing ring-opening polymerization (SCROP), that is also called ring-opening multibranching polymerization (ROMBP), an AB* monomer is used, where A is a heterocyclic ring capable of ring-opening polymerization, and B* is an initiating group for this ring opening polymerization. The AB* monomer may be combined with a cyclic A monomer, so that not every monomeric unit is a potential branching unit. Glycidol is an example of an AB* monomer that is suitable for use in SCROP (or ROMBP).

According to the above, chain growth methods may involve the use of either vinylic monomers (leading to poly-vinyl type of polymers) and/or cyclic monomers (typically leading to polyethers or polyesters). Vinylic monomers can be (meth)acrylates, (meth)acryl amides, vinyl ethers, vinyl esters or vinyl aryl monomers. Combinations of these type of vinyl monomers may be suitable as well. Examples of cyclic monomers are epoxides, oxetanes, caprolactones or urethanes.

### Preparing a HBP by an Addition Polymerization Reaction

The methods for preparation of HBPs described above are methods describing general ways to prepare HBPs, and are not limited thereto. It may be of interest to provide for a versatile method in which the HBP is synthesized in one synthetic step, after which the HBP can be used for the preparation of the crosslinked HBP with ion exchange groups, without having to resort to a post-modification reaction step(s) on the HBP.

In an aspect, a hyperbranched (co)polymer is prepared by a method, comprising:
providing one or more branching monomer(s),
optionally, providing one or more co-monomers,
providing an initiator, desirably a free radical initiator,
optionally, providing a chain transfer agent, and
reacting the branching monomer(s), the optional co-monomer(s), the initiator and the optional chain transfer reactant to form a hyperbranched (co)polymer.

In one embodiment, the reaction step may involve an addition polymerization reaction or, desirably, a free-radical polymerization reaction. In this method, the chemistry of the reactants (i.e. branching monomer, co-monomer, initiator, and/or chain transfer agent) and the reaction conditions may be selected such that crosslinking reactions may be prevented between HBP molecules that are being formed during the reacting step (i.e. preventing gelation or solidification).

In an embodiment, the branching monomer comprises at least two vinyl groups, the co-monomer comprises one vinyl, and the vinyl groups are suitable for addition polymerization. Desirably, the HBP thus prepared is a methacrylate based HBP or an acrylamide based HBP.

The preparation methods and reactants (e.g. branching monomer, co-monomer, initiator and/or chain transfer agent) described herein are versatile in the sense that the HBP can be prepared from readily available monomers and reactants, and that it can be tailored with respect to its properties by simply varying the used amounts of the branching monomer, the co-monomer(s), the initiator and the chain transfer agent. The extent of branching of the hyperbranched (co)polymer may be controlled by adjusting the amount of branching monomer in the polymerization reaction, while the use of the types and amounts of co-monomers may determine the type and amount of ion exchange groups and/or reactive groups in the HBP. Care may be taken to select a ratio between the chain transfer agent and the branching monomer such that gelation is prevented during the polymerization reaction, while still generating a HBP of a substantial molecular weight, e.g. with HBP molecules with a number average molecular weight (Mn) in the range of 250 Dalton to 100,000 Dalton (see for example O'Brien, Polymer, 41, 2000, 6027-6031). All branched monomers, co-monomers, initiators and/or chain transfer agents may comprise groups, or may transfer groups, such that the HBP formed may comprise these groups.

In an embodiment, the molar ratios of co-monomer(s): branching monomer(s):chain transfer agent (CTA) is between 5-80:0.5-20:1-30. The molar ratio of co-monomer(s):branching monomer(s) may be lower than 100:1, lower than 16:1, lower than 11:1, or lower than 7:1. The molar ratio between the branching monomer(s) and the chain transfer agent is desirably between 1:15 and 2:1.

When co-monomers are combined, for instance to provide for different chemistries in the HBP, e.g. see example reaction scheme 1 wherein 4-VP provides for a pyridine and HEMA/MMA provides for hydrophilic groups, one co-monomer may have a high reactivity with the CTA. Because of this high reactivity, a side product may be formed when the CTA and this co-monomer react. When this is the case, more of the CTA and more of this co-monomer may be used to compensate for the loss of reactants in the side product. For example, the co-monomer 4-vinyl pyridine can readily form a thioether side product with a linear primary thiol CTA. For instance, the amounts of CTA and/or co-monomer may be increased in the reaction mixture, whereas the amount of CTA and/or co-monomer incorporated is similar (see Table 1 and Table 2, compare e.g. 12A with 21).

In the reaction mixture, the amount of co-monomer(s) used is desirably in the range of 40 mol/mol % to 98 mol/mol %, the amount of branching monomer(s) and/or CTA is desirably from 2 mol/mol % to 50 mol/mol %. The initiator can be used in amounts varying from 0.01 mol/mol % to about 5 mol/mol %, relative to the amount of co-monomer(s), branching monomer(s) and CTA reactants. When higher molar percentages of initiator are used, the application of inhibitor additives or retarding agents (e.g. benzoyliminoacetate) may be considered. However, inhibitors or retardants may be avoided when about 1 mol/mol % of initiator is used.

The radical polymerization reaction may be performed using reaction conditions known to the skilled person, selecting a solvent (e.g. toluene or ethanol), concentration of reactants and monomers (i.e. solids), temperature and addition method of monomers, reactants and/or solvent as are known in the art for polymerization reactions. Desirably, the reaction is performed in alcohol such as ethanol, with concentrations ranging between 3 w/w % and 30 w/w % in solids or between 10 w/w % and 25 w/w %, at a temperature between 60° C.-90° C. Desirably, all monomers, reactants and solvents are premixed before the start of the reaction. Prior to a radical polymerization, the reaction mixture is desirably freed of oxygen, for example by purging it with an inert gas such as nitrogen.

The HBP may next be isolated. The HBP may for instance be isolated by precipitation or stirring in a non-solvent for the HBP. For this purpose the solvent in which the reaction was carried out may first be evaporated, prior to addition of the non-solvent. In the precipitation step by-products or less-preferred product fractions of low molecular weight may be removed.

Alternatively or additionally, the reaction mixture comprising the HBP may be directly used for the crosslinking reaction, forming a crosslinked HBP with ion exchange groups.

### The Branching Monomer

The branching monomer may be a molecule comprising two vinyl groups (i.e. an ethylenenically diunsaturated monomer). The branching monomer may also comprise more than two vinyl groups. These vinyl groups can be polymerized in an addition polymerization reaction. Many of such molecules are readily available, or may be prepared by reacting any di- or multifunctional molecule with a suitably reactive vinylic reactant. Examples include di- or multivinyl esters, di- or multivinyl amides, di- or multivinyl aryl compounds (including those with heterocyclic aryl groups), and di- or multivinyl alkyl/aryl ethers. The branching monomer may be hydrophilic or hydrophobic (but hydrophobic polysiloxane chains may be less desirable). The branching monomer can be either uncharged or negatively or positively charged. The branching monomer may be a single molecule, an oligomeric molecule or a polymeric molecule. The branching monomer may comprise a mixture of different branching monomers. The molecular weight of a branching monomer may be lower than 950 Dalton. The branching monomer may desirably be uncharged, and desirably a single compound.

Branching monomers include, but are not limited to, divinyl aryl monomers such as divinyl benzene; (meth)acrylate diesters such as alkylene di(meth)acrylates such as ethylene glycol di(meth)acrylate, propylene glycol di(meth)acrylate, 1,4-butylene glycol di(meth)acrylate; oligo alkylene glycol di(meth)acrylates such as e.g. tetraethyleneglycol di(meth)acrylate, poly(ethyleneglycol) di(meth)acrylate, poly (propyleneglycol) di(meth)acrylate; divinyl (meth)acrylamides such as methylene bisacrylamide; divinyl ethers such as poly(ethyleneglycol)divinyl ether; and tetra- or tri-(meth)acrylate esters such as pentaerythritol tetra (meth) acrylate, trimethylolpropane tri(meth)acrylate or glucose di- to penta (meth)acrylate. Desirable branching monomers may be divinyl benzene, α,ω-alkylene di(meth)acrylates or divinyl (meth)acrylamides. In an embodiment, the branching monomer may be α,ω-alkylene di(meth)acrylates such as ethylene glycol di(meth)acrylate and 1,4-butylene glycol di(meth)acrylate or divinyl (meth)acrylamides, such as methylene bisacrylamide.

In another embodiment, the branching monomer is a di(meth)acrylate, bisacrylamide, 1,4-butanediol dimethacrylate or methylene bisacrylamide.

### The Co-Monomer

The co-monomer may comprise any carbon-carbon unsaturated compound that can be polymerized in an addition polymerization reaction. Desirably when a co-monomer is to be polymerized in an addition polymerization reaction, it can be an ethylenenically monounsaturated monomer, e.g. vinyl or allyl compounds. Many of such molecules are readily available. Examples of co-monomers are vinyl acids, vinyl acid esters, vinyl aryl compounds (including those with heterocyclic aryl groups), vinyl acid anhydrides, vinyl amides, vinyl ethers, vinyl amines, vinyl aryl amines, vinyl nitriles, vinyl ketones, vinyl aldehydes, terminal alkylenes, and derivatives of these monomers as well as corresponding allyl variants thereof. The co-monomer can be hydrophilic or hydrophobic (but hydrophobic polysiloxane chains may be less desirable); anionic, cationic, uncharged or zwitterionic; it can be a single molecule, oligomeric or polymeric molecule. Desirably the molecular weight is lower than 950 Dalton. The co-monomer can be uncharged, negatively, or positively charged. A co-monomer may also comprise a mixture of different co-monomers, which may add flexibility, as the HBP may comprise a variety of different co-monomers with different chemistries. A single co-monomer may be desirable however.

Vinyl acids and derivatives thereof include (meth)acrylic acid and acid halides or activated esters thereof such as (meth)acryloyl chloride or N-hydroxysuccinimide (meth)acrylate, itaconic acid, maleic acid, vinyl phosphonic acid or vinyl phosphonates, vinylsulfonic acid or vinylsulfonates. Vinyl acid esters and derivatives thereof include linear or branched C1-20 alkyl(meth)acrylates such as methyl (meth)acrylate, stearyl (meth)acrylate and 2-ethyl hexyl (meth)acrylate, (meth)acrylates with alcohol and/or ether groups such as 2-hydroxyethyl (meth)acrylate, 3-hydroxypropyl (meth)acrylate, glycidyl (meth)acrylates and (meth)acrylic acid esters of (monomethoxy)glycols, (meth)acrylates with tertiary amine groups such as dimethylaminoethyl (meth)acrylate, diethylaminoethyl (meth)acrylate, diisopropylaminoethyl (meth)acrylate, mono-tert-butylaminoethyl (meth)acrylate, di(m)ethylaminopropyl (meth)acrylate and morpholinoethyl(meth)acrylate, (meth)acrylates with quaternary ammonium groups such as 2-(meth)acryloyloxy)ethyl-trimethylammonium chloride, (meth)acrylates with sulfonate or sulfonic acid groups such as 3-sulfopropyl (meth)acrylate salts, aryl(meth)acrylates such as benzyl (meth)acrylate, or

tri(alkyloxy)silylalkylene(meth)acrylates such as trimethoxysilylpropyl(meth)acrylate. Vinyl aryl compounds and derivatives thereof include styrene, acetoxystyrene, styrene sulfonic acid, styrene sulfonates, vinyl pyridines such as 4-vinyl pyridine, vinylbenzyl chloride, vinyl benzoic acid and (vinylbenzyl)trimethylammonium chloride. Vinyl acid anhydrides and derivatives thereof include maleic anhydride (a cyclic anhydride). Vinyl amides and derivatives thereof include (meth)acrylamide, N-isopropyl (meth)acrylamide, N-(2-hydroxypropyl)methacrylamide, N-vinyl pyrrolidone, N-vinylformamide, maleimide derivatives, methyl (meth)acrylamidoglycolate methyl ether, vinyl amides with tertiary amine groups such as N-[3-(dimethylamino)propyl]methacrylamide, vinyl amides with carboxylic acid or carboxylate groups, vinyl amides with quaternary ammonium groups such as 3-(metha)acrylamidopropyl-trimethylammonium chloride, vinyl amides with sulfonate groups such as 2-(meth)acrylamido-2-methyl-1-propanesulfonates, 2-(meth)acrylamido 2-ethyl propanesulfonates and 3-[N-(3-(meth)acrylamidopropyl)-N,N-dimethyl-aminopropane] sulfonates. Vinyl ethers and derivatives thereof include methyl vinyl ether and vinyl acetate. Vinyl aryl amines and derivatives thereof include vinyl aniline, vinyl pyridines, N-vinyl carbazole, vinyl imidazoles, vinyl triazoles and vinyl oxazoles. Vinyl nitriles and derivatives thereof include (meth)acrylonitrile. Vinyl aldehydes and derivatives thereof include acreolin.

It is possible to apply more than one co-monomer, as this provides the opportunity to incorporate ion-exchange groups and/or reactive groups into the HBP, while it also provides versatility to tailor the properties of the HBP. Indeed, co-monomers may be desirable that provide the HBP with cations, i.e. anion exchange groups, with anions (i.e. cation exchange groups), with reactive groups and/or with hydrophilic or hydrophobic groups. Hydrophilic co-monomers may for example have alcohol groups, e.g. a co-monomer may be 2-hydroxyethyl (metha)crylate. Hydrophobic co-monomers are for example styrene or 2-ethylhexyl (meth)acrylate.

Some reactive groups of co-monomers may also serve as ion exchange groups. For example, carboxylate and sulfonate groups (cation exchange groups) may be converted with amines to generate amides or sulfonamides. Therefore, co-monomers with sulfonate or carboxylate groups may be desirable.

In another embodiment, a co-monomer may comprise reactive groups that are precursors to ion exchange groups, such as for example amine groups, particularly tertiary amine groups or pyridine groups, as upon quaternization with e.g halides or tosylates these reactive groups render quaternary ammonium or pyridinium anion exchange groups, respectively. Alternatively or additionally, co-monomers bearing alkyl or benzyl halides may be used, as these can be quaternized with e.g. pyridines resulting in anion exchange groups. In yet another example, cyclic anhydride reactive groups render cation exchange groups by conversion with primary or secondary amines to give amide linkages and carboxylate groups.

Accordingly, examples of co-monomers are (meth)acrylates, (meth)acryl amides or vinyl aryl compounds that bear quaternary ammonium, tertiary amine, pyridine, cyclic anhydride, alkyl or benzyl halide, sulfonate or carboxylate groups. Non-limiting examples are 2-(meth)acryloyloxy)ethyl-trimethylammonium chloride, (vinylbenzyl)trimethylammonium chloride, 3-(metha)acrylamidopropyl-trimethylammonium chloride, di(m)ethylaminoethyl (meth)acrylates, di(m)ethylaminopropyl (meth)acrylates, N-3-(dimethylamino)-propyl methacrylamide, vinyl pyridine, maleic anhydride, vinylbenzyl chloride, 3-sulfopropyl (meth)acrylate salts, styrene sulfonates, 2-(meth)acrylamido-2-methyl-1-propanesulfonates, 2-(meth)acrylamido 2-ethyl propanesulfonates, (meth)acrylic acid and vinyl benzoic acid. 2-(meth)acryloyloxy)ethyl-trimethylammonium chloride, 3-(metha)acrylamidopropyl-trimethylammonium chloride, di-(methylamino)ethyl (meth)acrylates, 4-vinyl pyridine, styrene sulfonates and 2-(meth)acrylamido-2-methyl-1-propanesulfonates may be desirable, with more preference for di(methylamino)ethyl (meth)acrylates and 4-vinyl pyridine.

In one embodiment, the co-monomer is a vinylpyridine, (meth)acrylate, or an acrylamide, desirably the the co-monomer is 4-vinylpyridine, 2-hydroxyethylamethacrylate, methylmethacrylate, (dimethylamino)ethyl methacrylate, or N-isopropylacrylamide.

### The Initiator and the Chain Transfer Agent

The initiator is a molecule that can initiate a polymerization reaction. In case the polymerization reaction is a (free)-radical polymerization reaction, the initiator may be a (free)-radical initiator which may be any molecule known to initiate such a reaction, such as e.g. azo-containing molecules, peroxides, persulfates, redox initiators, or benzyl ketones. Such initiators may be activated via thermal, photolytic or chemical means. Examples of (free)-radical initiators are 2,2′-azobisisobutyronitrile (AIBN), azobis(4-cyanovaleric acid), benzoyl peroxide, cumylperoxide, 1-hydroxycyclohexyl phenyl ketone and hydrogenperoxide/ascorbic acid. The so-called iniferters may also be considered as initiators. AIBN may be desirable as (free)-radical initiator.

The chain transfer agent or reactant is a molecule that can control, limit and reduce the molecular weight during radical or free-radical polymerization via a chain transfer mechanism, as is known in the art. For example, a chain transfer agent in a radical polymerization reaction can react with the group of the polymer comprising the radical, such that the radical is transferred to the chain transfer agent. The result is that the chain transfer agent comprises the radical, and the polymerization of the group of the polymer that previously comprised the radical has stopped. The use of a chain transfer agent may prevent that the polymerization reaction will results in crosslinking reactions and gel formation. The chain transfer agent in a radical polymerization reaction may be any thiol-containing molecule and can be mono- or multifunctional. Examples of suitable thiols are linear or branched C2-C18 alkyl thiols such as dodecane 1-thiol, thioglycolic acid, thioglycerol, cysteine and cysteamine, 2-mercaptoethanol, thioglycerol, dithiothreitol (DTT) and ethylene glycol mono- (and di-)thio glycollate. Thiols may in addition bear reactive and/or ion exchange groups, such as carboxylic acids, amines or alcohols. Apart from thiols, other agents that can stabilize a radical and/or that are known to limit the molecular weight in a free-radical addition polymerization may also be considered. For example, hindered alcohols, organic complexes of cobalt are known as chain transfer catalysts, such as bis(borondifluorodimethyl-glyoximate) (CoBF) or cobalt oximes, reversible addition fragmentation transfer (RAFT) agents such as xanthates, dithioesters and dithiocarbonates, or alkyl halides. A desirable chain transfer agent is a thiol, desirably an organic thiol or an organic linear or branched C6-C20 alkyl thiol.

### Alternative Ways to Prepare HBPs

In addition to the methods above, describing e.g. a radical addition polymerization process, other methods to prepare HBPs may be considered. For example, reactions that result in HBPs with amine groups may be contemplated. Such HBPs may have been prepared via Michael type additions, often using the couple-monomer methodology (CMM), where monomers that bear primary amines, secondary amines and/or vinyl groups (e.g. vinyl acrylates or vinyl sulfones) are applied. See for example, Gao et al. (Macromolecules, 2000, 33, 7693-7699, Chem. Commun. 2001, 1, 107-108) or Feast et al. (Chem. Commun., 1997, pages 1877 and 2067). Other examples are those reported by Suzuki et al. who prepared a polyamine HBP using 5,5-dimethyl-6-ethenylperhydro-1,3-oxazin-2-one or 5-methyleneperhydro-1,3-oxazin-2-one as branching monomer. Polyethylene imine is a branched polymer with amine groups and it is prepared by SCVP-polymerization of the branching monomer aziridine.

HBPs can be prepared by any method and can thereafter be modified to arrive at the HBP that is suitable for preparation of a crosslinked HBP with ion exchange groups. Post-modification of an HBP may be performed to introduce ion exchange groups (either anion or cation), reactive groups, or groups that modify the hydrophilicity or hydrophobicity of the HBP. Desirably, HBPs are post-modified to acquire HBP-products with tertiary amine, pyridine or sulfonate groups, desirably tertiary amine groups. For this purpose, readily available commercial HBPs may be considered, such as those manufactured by Perstorp (“Boltorn” polyesters), by DSM (“Hybrane” poly(ester amide)s), by BASF (“Lupasol” polyethylene imines), HyperPolymers (polyglycerols), or by Polymer Factory (polyesters).

An Ion Exchange Membrane Comprising the Crosslinked HBP with Ion Exchange Groups

A crosslinked hyperbranched (co)polymer with ion exchange groups obtainable or obtained by the methods as described herein may be provided. Such a crosslinked hyperbranched (co)polymer with ion exchange groups may be in the form of a sheet. In an embodiment, there is provided an ion exchange membrane comprising the crosslinked hyperbranched (co)polymer containing ion exchange groups and that desirably is prepared as a sheet.

The crosslinked HBP may have gel like or solid like properties. The crosslinking reaction may be performed in a coating or a film, such that a sheet of crosslinked HBP is formed. The reactive film may be prepared by any processing technique feasible, such as for example by spraying a solution that contains both the HBP and the crosslinker onto a surface, or by applying such a solution onto a substrate by any coating technique, e.g. by a so-called doctor blading technique. The crosslinking reaction may be performed directly onto the surface or substrate of choice, for example onto a specific support layer or onto an electrode. Alternatively or additionally, the crosslinking reaction may be performed to prepare small sphere-like shaped crosslinked HBP particles (e.g. microspheres), for example by performing the crosslinking in small droplets, which may be used to prepare e.g. a paste, such that the crosslinked HBP may be applied to irregular surfaces or shapes.

The crosslinking step may also at first instance be done in a reactor, and may subsequently be transferred to the object, substrate or surface of choice, where the reaction may be completed. Since during the crosslinking step the viscosity of the reaction mixture may increase, due to the crosslinks that are formed, the properties of the reaction mixture may change from a liquid to a more viscous, paste like mixture which may make it convenient to apply the reaction mixture to a surface, or a mold, which may even have an irregular surface. Hence, it may be advantageous to transfer the reaction mixture during the reaction to an object, substrate or surface of choice, where the reaction will be completed.

In another aspect, an ion exchange membrane is provided which comprises sheets of crosslinked HBP with ion exchange groups, wherein the thickness of the sheets of crosslinked HBP with ion exchange groups is desirably less than 200 micrometers, less than 100 micrometers, or less than 60 micrometers.

The concentration of the ion exchange groups, either cationic or anionic, in the crosslinked HBP with ion exchange groups is desirably higher than 0.2 mmol per gram, higher than 0.8 mmol per gram, higher than 1.4 mmol per gram, higher than 2.0 mmol per gram or higher than 2.5 mmol per gram. These numbers refer to a dry crosslinked HBP with ion exchange groups. Desirably, the crosslinked HBP with ion exchange groups comprises between 25% and 95%, between 40% and 85%, or between 55% and 80% by weight of the HBP. The concentrations of ion exchange groups in mmol/g of dry crosslinked HBP with ion exchange groups, and percentages by weight of HBP in the dry crosslinked HBP with ion exchange groups, may, for example, be calculated from the amounts of HBP and crosslinker that have been used in the preparation of the crosslinked HBP membrane material.

Furthermore, the crosslinked HBP with ion exchange groups material may comprise additional hydrophilic groups, such as for example alcohol or amide groups, and/or additional hydrophobic groups, such as for example C₈ or higher alkyl or alkylene groups, where these hydrophilic and/or hydrophobic groups may originate from the crosslinker and/or from the HBP. In this way, the crosslinked hyperbranched (co)polymer with ion exchange groups may be more compatible with water and/or may improve the electrical conductive properties of the crosslinked hyperbranched (co)polymer with ion exchange groups and/or may improve the performance of the membrane material.

The (sheets of) crosslinked HBP with ion exchange groups, that may be used for ion exchange membranes, may have little or no curling or delamination when after preparation they are brought in contact with water and also at the same time may show little swelling. Furthermore, advantageous permselectivities may be obtained with crosslinked HBP with ion exchange groups. As is described in the examples, for instance, permselectivities higher than 90% may be obtained with sheets in the range of 40 micrometers (see, e.g., example 17). Permselectivity or permeability selectivity, is defined as the percentage of cations or anions, of the total amount of ions that may be taken up by a membrane, in this case a membrane comprising the crosslinked HBP with ion exchange groups. When a membrane has a permselectivity of 100% for anions, this means that 100% of the ions may be taken up by the membrane are anions. When the permselectivity is reduced e.g. by 5% to a permselectivity of 95%, this means that 95% of the ions that may be are taken up by the membrane are anions, and 5% are cations. Please note that for ion exchange membranes, especially for those applied in FTCs, every percent increase in permselectivity may be very valuable, with 100% being the maximum selectivity achievable. Also, a low resistance, as low as 5 ohm*cm², or even as low as 1.5 ohm*cm², have been recorded for the prepared sheets of crosslinked HBP with ion exchange groups in example 17.

Accordingly, in an embodiment, there is provided the use of a crosslinked hyperbranched (co)polymer with ion exchange groups as described herein, of an ion exchange membrane as described herein, or of an apparatus as described herein, for the removal of ions from water.

These and other aspects, features and advantages will become apparent to those of ordinary skill in the art from reading the description and the appended claims. For the avoidance of doubt, any feature of one aspect of the present invention may be utilized in any other aspect of the invention. It is noted that the examples given in the description below are intended to clarify embodiments of the invention and are not intended to limit the invention to those examples per se. Similarly, all percentages are weight/weight percentages unless otherwise indicated. Numerical ranges expressed in the format “from x to y” or “x-y” are understood to include x and y. When for a specific feature multiple ranges are described in the format “from x to y”, it is understood that all ranges combining the different endpoints are also contemplated.

### EXAMPLES

### Experimental Details

All solvents were of AR quality if not stated otherwise and were purchased from commercial sources (Biosolve or Acros). Deuterated solvents were purchased from Cambridge Isotope Laboratories and were dried over molsieves. The co-monomers 4-vinyl pyridine (4-VP) (95%), 2-hydroxyethyl methacrylate (HEMA) (97%), methyl methacrylate (MMA) (99%), 2-(dimethylamino)ethyl methacrylate (DAMA) (98%), 3-(dimethylamino)propyl methacrylamide (DAPMA), N-(2-hydroxyethyl)-acrylamide (HEAA), the crosslinker 1,10-dibromodecane and the branching monomers methylenebisacrylamide (MBAA) (98%) and butanediol dimethacrylate (di-MA) (95%), were purchased from Aldrich. The chain transfer agent 1-dodecane thiol (99%), the co-monomer N-isopropylacrylamide (IAA) (99%), the initiator 2,2′-azo-bis(2-methylpropionitrile) (AIBN) (98%) and the crosslinker 1,6-diiodohexane (97%) were purchased from Acros. ¹H—NMR spectra were recorded on a Varian Mercury Plus 200 MHz NMR spectrometer, where ¹H—NMR chemical shifts are given in ppm, and were determined using tetramethylsilane (TMS) as internal standard (0 ppm). Infrared spectra of samples were recorded on a Perkin Elmer Spectrum One 1600 ATR FT-IR spectrometer. Wavenumbers are given in cm⁻¹. GPC (or SEC) chromatograms of the polymers were measured using 10 mM of LiBr in DMF as eluent, applying a 1 mL/min eluent flowrate, a sample concentration of 2 mg/mL in 10 mM of LiBr DMF and an injection volume of 20 microL. A Polymer Laboratories PL-GPC50 Plus Integrated GPC system was used, equipped with a Polymer Standards Service (PSS) Gram analytical linear M column (dimensions 8×300 mm, particle-size 10 micro-m, mass range: 500-1000000 Da) that was operated at 50° C. and applying refractive index (RI) detection. Calibration was performed with polyethyleneoxide reference standards. Elemental analysis was performed on a Perkin Elmer 2400 machine, where elemental contents are given in weight percentages. DSC was performed on a TA Q2000 instrument, where monitored samples are kept under a nitrogen atmosphere. Glass transition temperatures (Tg) are given as observed during the second heating run using a heating rate of 40° C./min.

The below examples serve to show some possibilities of embodiments of the invention, and are non-limiting to the invention.

### The Preparation of the HBP Copolymer

Hyperbranched copolymers were synthesized in addition co-polymerization reactions. Methacrylate based HBPs with pyridine groups or with tertiary amine groups were prepared (see Scheme 1 and Scheme 2), as well as (meth)acrylamide based HBPs with pyridine groups or with tertiary amine groups (see Scheme 3 and Scheme 4). The shown monomers may be combined in other ways as well, e.g. in Schemes 3 and 4 the di-ester braching monomer di-MA (from Schemes 1 and 2) may be applied instead of the bisacrylamide MBAA.

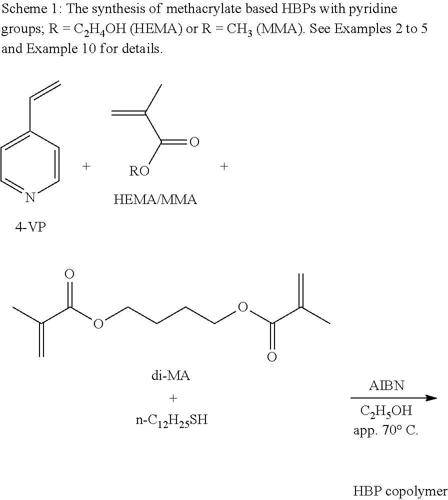

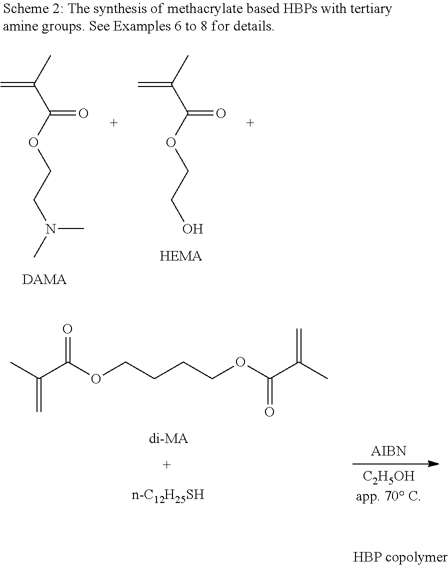

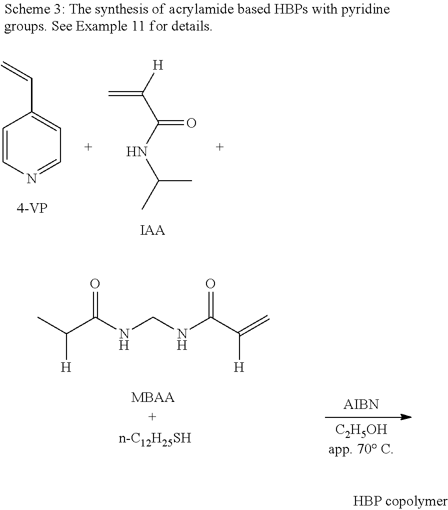

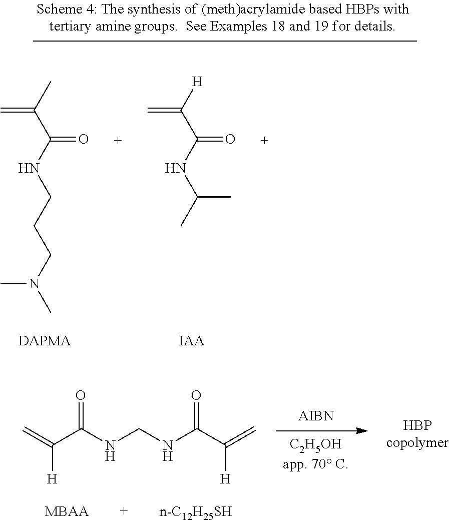

For the methacrylate based HBPs (Scheme 1 and Scheme 2), 1,4-butanediol dimethacrylate (di-MA) was selected as the branching monomer, while for the (meth)acrylamide based HBPs (Scheme 3 and Scheme 4) methylene bisacrylamide (MBAA) was chosen.

All polymerization reactions were reproducible. Similar reaction conditions were selected for all polymerizations, using ethanol as solvent, 1-dodecanethiol as chain transfer agent, applying approximately 1 mole-% of AIBN-initiator with respect to the total moles of vinylic groups, and employing a reaction temperature of approximately 70° C. The conversion during reaction was monitored with ¹H—NMR.

When 4-vinyl pyridine (4-VP) was used as a co-monomer (Scheme 1 and Scheme 3), the formation of a side-product was observed. This thioether side-product was formed by the reaction of 4-vinyl pyridine with dodecane thiol, see also: A. R. Katritzky et al., J. Org. Chem., 1986, 51, 4914. Purification of the polymerization reaction mixture was performed by precipitation in heptane, thus effectively removing side-products.

When methylene bisacrylamide (MBAA) was used as co-monomer (particularly Scheme 4), some thioether side-product was formed as well, in this case by reaction of methylene bisacrylamide (MBAA) with two equivalents of dodecane thiol leading to formation of the corresponding dithioether.

When only methacrylate monomers were used (Scheme 2), a thioether side-product was not observed, which may result in higher yields of HBP. Additionally, as reactivities of the methacrylate monomers are similar, a more random incorporation of monomers in these HBPs may be expected.

Generally, dimethyl amino tertiary amines are considered more nucleophilic than pyridines. Accordingly, using co-monomers with tertiary amines, for example the applied DAMA or DAPMA monomers (Scheme 2 and Scheme 4), instead of applying the vinyl pyridine co-monomer (Schemes 1 and 3), may result in HBPs that are more reactive towards alkane dihalides in the crosslinking-quaternization step.

The (meth)acrylamide based hyperbranched copolymers (Scheme 3 and Scheme 4) may be polymerized without the use of a hydrophilic co-monomer such as HEMA, as the amides provide hydrophilicity already. Amide based HBPs may be of interest as they may be more stable towards hydrolysis, as compared to the methacrylate based HBPs. Finally, the isolated HBPs as described below did not show signs of degradation upon routine storage at room temperature or at 4° C., and were thus regarded stable.

Please note that the linear copolymers and the HBPs in the examples below are indicated with a number as this makes it more convenient to refer to the different polymers that have been synthesized.

### COMPARATIVE EXAMPLE 1

### Linear Copolymer 10B

4-Vinyl pyridine (7.91 g, 71.43 mmol), 2-hydroxyethyl methacrylate (3.57 ml, 28.57 mmol), n-dodecane thiol (10.33 ml, 42.86 mmol) and AIBN (167 mg, 1 mmol) were dissolved in ethanol (67 ml) in a 3-neck 250 ml round-bottom flask under stirring. The beige, clear solution was purged with argon for 1 h while stirring. A reflux condenser was fitted and the reaction mixture was then stirred and heated at an oil bath temperature of 75° C. for 15 h, and was kept under an argon atmosphere. The solvent was evaporated in vacuo and the orange residual syrup redissolved into ethanol (15 ml) and subsequently precipitated into an ice-cold mixture of heptane (200 ml) and diisopropyl ether (100 ml) during which a beige slurry formed. The slurry was filtered over a glass filter and the residue was washed twice with an ice-cold mixture of heptane (33 ml) and diisopropyl ether (17 ml). Overnight drying of the residue in vacuum yielded the reference linear copolymer 10B as a light-yellow solid (7.19 g, 36%). ¹H—NMR (CDCl₃ and CD₃OD): δ=8.42 (pyridine, broad peak (bp)), 7.08 (pyridine, bp), 4.08 (ester, bp), 3.78 (ester/alcohol, bp), 3.53 (ester/alcohol, bp), 2.5-0.4 (multiple signals, bp), 1.25 (alkyl tail CH₂-groups), 0.88 ppm (triplet (t), ³J(H,H)=6.3 Hz, alkyl tail CH₃-group). FT-IR (ATR): ν (cm⁻¹)=3233, 2925, 2854, 1721, 1598, 1558, 1454, 1417, 1386, 1220, 1183, 1145, 1083, 1070, 1026, 1003, 994, 897, 820, 755; GPC (DMF-LiBr): Mn=0.2 kg/mol, Mw=0.3 kg/mol, PDI=1.7; Elemental analysis: C, 67.23; H, 7.88; N, 5.58. Number of pyridine groups as derived from ¹H NMR data: 4.2 mol/kg linear copolymer. T_{g}=39° C.

### EXAMPLE 2

### HBP 8C

4-Vinyl pyridine (9.65 g, 87.2 mmol), 2-hydroxyethyl methacrylate (3.63 ml, 29.1 mmol), 1,4-butanediol dimethacrylate (0.68 ml, 2.9 mmol), n-dodecane thiol (10.51 ml, 43.6 mmol) and AIBN (209 mg, 1.25 mmol) were dissolved in ethanol (125 ml) in a 3-neck 250 ml round-bottom flask under stirring. The beige, clear solution was purged with argon for 1 h while stirring. A reflux condenser was fitted and the reaction mixture was stirred and heated at an oil bath temperature of 76° C. for 17 h, and was kept under argon. The solvent was evaporated in vacuo and the orange residual syrup redissolved into ethanol (20 ml) and subsequently precipitated into ice-cold heptane (350 ml) during which an orange-beige mass formed. The supernatant was decanted and the residue was dried overnight in vacuum to yield HBP 8C as a yellow, glassy solid (7.47 g, 33%). ¹H—NMR (CDCl₃ and CD₃OD): δ=8.45 (pyridine, bp), 7.02 (pyridine, bp), 4.04 (ester, bp), 3.78 (ester/alcohol, bp), 3.52 (ester/alcohol, bp), 2.5-0.4 (multiple signals, bp), 1.25 (alkyl tail CH₂), 0.88 ppm (t, ³J(H,H)=6.4 Hz, alkyl tail CH₃). FT-IR (ATR): ν (cm⁻¹)=3233, 2925, 2854, 1721, 1598, 1558, 1454, 1417, 1386, 1220, 1183, 1145, 1083, 1070, 1026, 1003, 994, 897, 820, 755; GPC (DMF-LiBr): Mn=1.1 kg/mol, Mw=4.2 kg/mol, PDI=3.7; Elemental analysis: C, 68.84; H, 7.85; N, 6.30. Number of pyridine groups, as derived from ¹H NMR data: 4.7 mol/kg HBP. T_{g}=57° C.

### EXAMPLE 3

### HBP 12B

4-Vinyl pyridine (7.91 g, 71.43 mmol), 2-hydroxyethyl methacrylate (2.18 ml, 17.42 mmol), 1,4-butanediol dimethacrylate (1.33 ml, 5.71 mmol), n-dodecane thiol (10.33 ml, 42.86 mmol) and AIBN (167 mg, 1 mmol) were dissolved in ethanol (67 ml) in a 3-neck 250 ml round-bottom flask under stirring. The beige, clear solution was purged with argon for 1 h while stirring. A reflux condenser was fitted and the reaction mixture was stirred and heated at an oil bath temperature of 75° C. for 18 h, and was kept under an argon atmosphere. The solvent was evaporated in vacuo and the orange residual syrup redissolved into ethanol (15 ml) and subsequently precipitated into heptane (400 ml) during which a beige mass formed. The supernatant was decanted and the residue was redissolved into ethanol (20 ml) and precipitated into heptane (400 ml) during which a beige mass formed. The supernatant was decanted and the residue was dried overnight in vacuum to yield HBP 12B as a beige, glassy solid (6.44 g, 33%). ¹H—NMR (CDCl₃): δ=8.46 (pyridine, bp), 6.98 (pyridine, bp), 4.01 (ester, bp), 3.83 (ester/alcohol, bp), 3.6 (ester/alcohol, broad shoulder), 2.5-0.4 (multiple signals, bp), 1.25 (alkyl tail CH₂), 0.88 ppm (t, ³J(H,H)=6.1 Hz, alkyl tail CH₃). FT-IR (ATR): ν (cm⁻¹)=3249, 3025, 2924, 2853, 1721, 1598, 1558, 1452, 1416, 1386, 1220, 1176, 1085, 1070, 1026, 993, 820, 755; GPC (DMF-LiBr): Mn=1.8 kg/mol, Mw=3.8 kg/mol, PDI=2.1; Elemental analysis: C, 68.14; H, 7.95; N, 5.64. Number of pyridine groups as derived from ¹H NMR data: 4.1 mol/kg HBP. T_{g}=66° C.

### EXAMPLE 4

### HBP 10A

4-Vinyl pyridine (7.91 g, 71.43 mmol), 2-hydroxyethyl methacrylate (1.43 ml, 11.43 mmol), 1,4-butanediol dimethacrylate (2.00 ml, 8.57 mmol), n-dodecane thiol (10.33 ml, 42.86 mmol) and AIBN (167 mg, 1 mmol) were dissolved in ethanol (67 ml) in a 3-neck 250 ml round-bottom flask under stirring. The beige, clear solution was purged with argon for 1 h while stirring. A reflux condenser was fitted and the reaction mixture was stirred and heated in an oil bath temperature of 75° C. for 15 h, while keeping the mixture under an argon atmosphere. The solvent was evaporated in vacuo and the orange residual syrup redissolved into ethanol (15 ml) and subsequently precipitated into an ice-cold mixture of heptane (200 ml) and diisopropyl ether (100 ml) during which a beige slurry formed. The slurry was filtered over a glass filter and the residue was washed twice with an ice-cold mixture of heptane (33 ml) and diisopropyl ether (17 ml). Overnight drying of the residue in vacuum yielded HBP 10A as a light-yellow, glassy solid (8.44 g, 43%). ¹H—NMR (CDCl₃): δ=8.47 (pyridine, bp), 6.98 (pyridine, bp), 4.08 (ester, bp), 3.85 (ester/alcohol, bp), 3,6 (ester/alcohol, broad schoulder), 2.5-0.4 (multiple signals, bp), 1.25 (alkyl tail CH₂), 0.88 ppm (t, ³J(H,H)=6.3 Hz, alkyl tail CH₃). FT-IR (ATR): ν (cm⁻¹)=3262, 3024, 2924, 2853, 1721, 1598, 1558, 1466, 1452, 1416, 1385, 1219, 1171, 1087, 1069, 1028, 993, 957, 819, 755; GPC (DMF-LiBr): Mn=1.1 kg/mol, Mw=3.6 kg/mol, PDI=3.4; Elemental analysis: C, 69.77; H, 8.20; N, 5.47. Number of pyridine groups as derived from ¹H NMR data: 4.1 mol/kg HBP. T_{g}=30° C.

### EXAMPLE 5

### HBP 12A

4-Vinyl pyridine (7.91 g, 71.43 mmol), 2-hydroxyethyl methacrylate (0.76 ml, 5.71 mmol), 1,4-butanediol dimethacrylate (2.67 ml, 11.43 mmol), n-dodecane thiol (10.33 ml, 42.86 mmol) and AIBN (167 mg, 1 mmol) were dissolved in ethanol (67 ml) in a 3-neck 250 ml round-bottom flask under stirring. The beige, clear solution was purged with argon for 1 h while stirring. A reflux condenser was fitted and the reaction mixture was stirred and heated at an oil bath temperature of 75° C. for 18 h, whilst under an argon atmosphere. The solvent was evaporated in vacuo and the orange residual syrup redissolved into ethanol (15 ml) and subsequently precipitated into heptane (300 ml) during which a beige mass formed. The supernatant was decanted and the residue was redissolved into ethanol (20 ml) and again precipitated into heptane (400 ml) during which a beige mass formed. The supernatant was decanted and the residue was dried in vacuum for 48 hrs to yield HBP 12A as a beige, glassy solid (6.30 g, 32%). ¹H—NMR (CDCl₃): δ=8.48 (pyridine, bp), 6.99 (pyridine, bp), 4.07 (ester, bp), 3.84 (ester/alcohol, bp), 3.55 (ester/alcohol, bp), 2.5-0.4 (multiple signals, bp), 1.26 (alkyl tail CH₂), 0.90 ppm (t, ³J(H,H)=6.1 Hz, alkyl tail CH₃). FT-IR (ATR): ν (cm⁻¹)=3255, 2925, 2854, 1721, 1597, 1558, 1451, 1415, 1385, 1219, 1167, 1069, 1028, 993, 819, 754; GPC (DMF-LiBr): Mn=3.1 kg/mol, Mw=7.5 kg/mol, PDI=2.4; Elemental analysis: C, 69.99; H, 8.02; N, 5.63. Number of pyridine groups as derived from ¹H NMR data: 4.1 mol/kg HBP. T_{g}=71° C.

### EXAMPLE 6

### HBP 21

2-(Dimethylamino)ethyl methacrylate (9.56 g, 59.5 mmol), 2-hydroxyethyl methacrylate (2.25 ml, 17.9 mmol), 1,4-butanediol dimethacrylate (2.65 ml, 11.3 mmol), dodecane thiol (4.30 ml, 17.9 mmol) and AIBN (167 mg 1.0 mmol) were dissolved in ethanol (67 ml) in a 3-neck 100 ml round-bottom flask under stirring. The colorless, clear solution was purged with argon for 1 h while stirring. A reflux condenser was fitted and the reaction mixture was heated at an oil bath temperature of 73° C. under argon and stirring for 19 h. The solvent was evaporated in vacuo and the orange residual syrup was mixed with heptane (100 ml) and heated at 70° C. for 2 h to give a beige emulsion. The latter was allowed to reach room temperature during which phase separation occurred into a beige viscous bottom layer and a clear, dark-yellow liquid top layer. This layer was decanted after which the residue was dried for two days in vacuum in the presence of KOH as drying agent to yield HBP 21 as a sticky, dark-yellow solid (12.57 g, 70%). ¹H—NMR (CDCl₃): δ=4.08 (ester, bp), 3.82 (alcohol, bp), 2.5-0.6 (multiple bp), 2.57 (amine CH₂, bp), 2.28 (amine CH₃, s), 1.25 (alkyl tail CH₂), 0.88 ppm (alkyl tail CH₃); FT-IR (ATR): ν (cm⁻¹)=2927, 2855, 2823, 2771, 1724, 1456, 1388, 1270, 1238, 1147, 1099, 1063, 1019, 964, 853, 778, 749; GPC (DMF-LiBr): Mn=3.5 kg/mol, Mw=13.4 kg/mol, PDI=3.9; Elemental analysis: C, 61.52; H, 9.31; N, 4.16. Number of amine groups as derived from ¹H NMR data: 3.6 mol/kg HBP. T_{g}=1° C.

### EXAMPLE 7

### HBP 19

2-(Dimethylamino)ethyl methacrylate (5.74 g, 35.7 mmol), 2-hydroxyethyl methacrylate (0.63 ml, 5.0 mmol), 1,4-butanediol dimethacrylate (2.25 ml, 9.64 mmol), dodecane thiol (2.60 ml, 10.7 mmol) and AIBN (100 mg 0.6 mmol) were dissolved in ethanol (40 ml) in a 3-neck 100 ml round-bottom flask under stirring. The colorless, clear solution was purged with argon for 1 h while stirring. A reflux condenser was fitted and the reaction mixture was heated at an oil bath temperature of 73° C. under argon and stirring for 21 h. The solvent was evaporated in vacuo and the orange residual syrup was mixed with heptane (300 ml) and refluxed for 2 h to give a beige emulsion. The latter was allowed to settle overnight resulting in a dark-yellow bottom layer and a clear, dark-yellow, liquid top layer. This layer was decanted after which the residue was dried for two days in vacuum in the presence of KOH as drying agent to yield HBP 19 as a sticky, yellow solid (6.30 g, 59%). ¹H—NMR (CDCl₃): δ=4.07 (ester, bp), 3.81 (alcohol, bp), 2.5-0.6 (multiple bp), 1.25 (alkyl tail CH₂), 0.88 ppm (alkyl tail CH₃); FT-1R (ATR): ν (cm⁻¹)=2926, 2854, 2822, 2770, 1724, 1456, 1387, 1268, 1236, 1145, 1100, 1062, 1040, 1019, 964, 852, 778, 749; GPC (DMF-LiBr): Mn=4.7 kg/mol, Mw=17.1 kg/mol, PDI=3.7; Elemental analysis: C, 62.33; H, 9.38; N, 3.99. Number of amine groups as derived from ¹H NMR data: 3.9 mol/kg HBP. T_{g}=9° C.

### EXAMPLE 8

### HBP 20

2-(Dimethylamino)ethyl methacrylate (9.55 g, 59.5 mmol), 1,4-butanediol dimethacrylate (4.75 ml, 20.2 mmol), dodecane thiol (4.30 ml, 17.9 mmol) and AIBN (167 mg 1.0 mmol) were dissolved in ethanol (67 ml) in a 3-neck 250 ml round-bottom flask under stirring. The colorless, clear solution was purged with argon for 1 hr while stirring. A reflux condenser was fitted and the reaction mixture was heated at an oil bath temperature of 73° C. under argon and stirring for 19 h. The solvent was evaporated in vacuo and the orange residual syrup was mixed with acetonitrile (50 ml) and heated at 80° C. for 1 h under stirring to give an orange-beige emulsion. After allowing to reach room temperature the mixture separated into a beige, viscous bottom layer and an almost clear, orange top layer. The latter was decanted after which the residue was dried for two days in vacuum in the presence of KOH as drying agent to yield HBP 20 as a sticky, yellow solid (12.35 g, 70%). ¹H—NMR (CDCl₃): δ=4.08 (ester, bp), 2.5-0.6 (multiple bp), 1.26 (alkyl tail CH₂), 0.88 ppm (t, ³J(H,H)=6.2 Hz, alkyl tail CH₃); FT-IR (ATR): ν (cm⁻¹)=2925, 2854, 2822, 2770, 1724, 1456, 1387, 1268, 1236, 1146, 1100, 1062, 1041, 1019, 956, 853, 778, 750; GPC (DMF-LiBr): Mn=6.8 kg/mol, Mw=71.9 kg/mol, PDI=10.6; Elemental analysis: C, 63.72; H, 9.57; N, 3.89. Number of amine groups as derived from ¹H NMR data: 2.9 mol/kg HBP. T_{g}=not determined.

### COMPARATIVE EXAMPLE 9

### Linear Copolymer 22A

4-Vinyl pyridine (11.88 g, 107.1 mmol), methyl methacrylate (4.65 ml, 42.9 mmol), dodecane thiol (15.5 ml, 64.3 mmol) and AIBN (249 mg, 1.5 mmol) were dissolved in ethanol (100 ml) in a 3-neck 250 ml round-bottom flask under stirring. The beige, clear solution was purged with argon for 1 h while stirring. A reflux condenser was fitted and the reaction mixture was heated at an oil bath temperature of 70° C. under argon and stirring for 16 h. The solvent was evaporated in vacuo and the orange residual syrup mixed with heptane (100 ml). This mixture was heated to reflux under stirring to give a beige emulsion. After 0.5 h, the emulsion was allowed to reach room temperature during which time the orange material settled and an orange, clear supernatant formed. The latter was decanted and the residue was mixed with heptane (100 ml) and subsequently heated to 80° C. Stirring of the viscous mixture was performed for 10 minutes after which the mixture was allowed to reach room temperature. An almost colorless, turbid supernatant formed which was decanted and the beige residue was collected, dried under vacuum at room temperature and subsequently mixed with pentane (100 ml) to give a beige suspension upon grinding and stirring. The suspension was allowed to settle, so that a supernatant formed that was then decanted. The residue was collected and dried under vacuum at room temperature in the presence of KOH to give linear copolymer 22A as a beige powder (7.85 g, 27%). ¹H—NMR (CDCl₃): δ=8.46 (pyridine, bp), 6.87 (pyridine, bp), 3.54, 3.35 and 2.91 (ester/alcohol, bp), 2.5-0.4 (multiple bp), 1.24 (alkyl tail CH₂), 0.86 ppm (t, ³J(H,H)=6.1 Hz, alkyl tail CH₃); FT-IR (ATR): ν (cm⁻¹)=3423, 3024, 2988, 2925, 2853, 1725, 1597, 1557, 1448, 1416, 1358, 1219, 1196, 1134, 1069, 993, 820, 754; GPC (DMF-LiBr): Mn=0.7 kg/mol, Mw=1.5 kg/mol, PDI=2.1; Elemental analysis: C, 71.74; H, 7.79; N, 7.46. Number of pyridine groups as derived from ¹H NMR data: 5.5 mol/kg linear copolymer. T_{g}=41° C.

### EXAMPLE 10

### HBP 22B

4-Vinyl pyridine (11.86 g, 107.1 mmol), methyl methacrylate (0.90 ml, 8.6 mmol), 1,4-butanediol dimethacrylate (4.0 ml, 17.1 mmol), dodecane thiol (15.50 ml, 64.3 mmol) and AIBN (251 mg, 1.5 mmol) were dissolved in ethanol (100 ml) in a 3-neck 250 ml round-bottom flask under stirring. The beige, clear solution was purged with argon for 1 h while stirring. A reflux condenser was fitted and the reaction mixture was heated at an oil bath temperature of 70° C. under argon and stirring for 21 h. The solvent was evaporated in vacuo and the orange residual syrup mixed with heptane (100 ml). This mixture was heated to 80° C. under stirring to give a beige emulsion. After 0.5 h, the emulsion was allowed to reach room temperature during which time the material settled and an orange, clear supernatant formed. The latter was decanted and the dark-yellow residue was mixed with heptane (100 ml) and subsequently heated to 80° C. Manual stirring of the viscous mixture was performed for 10 minutes after which the mixture was allowed to reach room temperature. An almost colorless, turbid supernatant formed which was decanted and the dark-yellow residue was collected and dried to remove the ethanol used. The residue was suspended in pentane (100 ml) under grinding and stirring for 1 h and the beige suspension was allowed to settle for 1 h. The formed supernatant was decanted and the residue washed with pentane (25 ml) and decanted again. Drying of the residue under vacuum in the presence of KOH gave HBP 22B as a beige powder (5.51 g, 19%). ¹H—NMR (CDCl₃): δ=8.47 (pyridine, bp), 6.96 (pyridine, bp), 4.02 and 3.60 (ester/alcohol, bp), 2.5-0.4 (multiple bp), 1.25 (alkyl tail CH₂), 0.88 ppm (t, ³J(H,H)=6.2 Hz, alkyl tail CH₃); FT-IR (ATR): ν (cm⁻¹)=3423, 3025, 2924, 2853, 1722, 1597, 1557, 1495, 1465, 1457, 1415, 1386, 1219, 1169, 1132, 1069, 1032, 993, 973, 819, 754; GPC (DMF-LiBr): Mn=2.8 kg/mol, Mw=7.4 kg/mol, PDI=2.7; Elemental analysis: C, 71.28; H, 8.11; N, 5.69. Number of pyridine groups as derived from ¹H NMR data: 4.9 mol/kg HBP. T_{g}=54° C.

### EXAMPLE 11

### HBP 23

4-Vinyl pyridine (11.88 g, 107.1 mmol), N-isopropyl acrylamide (1.97 g, 17.1 mmol), methylene bisacrylamide (2.02 g, 12.7 mmol), dodecane thiol (15.50 ml, 64.3 mmol) and AIBN (252 mg, 1.5 mmol) were dissolved in ethanol (100 ml) in a 3-neck 250 ml round-bottom flask under stirring. The beige, foggy solution was purged with argon for 1 h while stirring. A reflux condenser was fitted and the reaction mixture was heated at an oil bath temperature of 73° C. under argon and stirring upon which the reaction mixture turned clear. The reaction mixture was heated and stirred for 21 h. The solvent was evaporated in vacuo and the orange residual syrup was mixed with heptane (100 ml). This mixture was heated to 80° C. under stirring to give a beige suspension. After 1 h, the suspension was allowed to reach room temperature and filtered over a Büchner funnel giving a beige residue that was washed with heptane (3×25 ml). The residue was subsequently suspended in acetonitrile (50 ml) and heated to 80° C. After 0.5 h stirring, the mixture was allowed to reach room temperature and settled overnight. A residue and an orange, clear supernatant appeared and the latter was decanted. The residue was mixed with acetonitrile (50 ml) under grinding and stirring giving a beige suspension, that was filtered over a Büchner funnel giving a beige residue that was washed with acetonitrile (2×25 ml) and dried in a vacuum oven at 30° C. in the presence of KOH for two days giving HBP 23 as a beige powder (6.15 g, 22%). ¹H—NMR (CDCl₃ and CD₃OD): δ=8.41 (pyridine, bp), 6.99 (pyridine, bp), 4.50 (CH₂ bisacrylamide, bp), 3.94 (CH N-isopropylacrylamide, bp), 2.5-0.4 (multiple bp), 1.25 (alkyl tail CH₂), 0.88 ppm (t, ³J(H,H)=6.2 Hz, alkyl tail CH₃); FT-1R (ATR): ν (cm⁻¹)=3287, 3025, 2925, 2854, 1665, 1598, 1526, 1456, 1416, 1385, 1367, 1220, 1175, 1116, 1070, 994, 821; GPC (DMF-LiBr): Mn=1.3 kg/mol, Mw=3.9 kg/mol, PDI=3.0; Elemental analysis: C, 66.96; H, 8.16; N, 11.52. Number of pyridine groups as derived from ¹H NMR data: 4.8 mol/kg HBP. T_{g}=134° C.

### EXAMPLE 12

### Compositional Data of the HBPs

The relative molar amounts of the branching monomers, co-monomers and reactants have been used in the polymerization reactions from Example 1 to Example 11 have been compiled in Table 1 below. Compositional data from the corresponding isolated HBPs have been compiled in Table 2, where these data have been derived or estimated from ¹H NMR spectral data, as far as this was feasible. See Schemes 1 to 3 for explanations of the 4-VP, DAMA, HEMA, MMA, IAA, MBAA and di-MA codes for the monomers. Note that 1 mole of di-MA or MBAA branching monomer contains 2 moles of vinylic groups; (L) denotes linear reference copolymers.

TABLE 1
Applied compositions of the reaction mixtures used in Examples 1 to 11

| Example | | Molar ratio of reactants | | | | | | | |
|---|---|---|---|---|---|---|---|---|---|
| Entry | HBP | 4-VP | HEMA | MMA | DAMA | IAA | di-MA | MBAA | C12-thiol |
| 1 | 10B (L) | 25 | 10 | | | | 0 | | 15 |
| 2 | 8C | 30 | 10 | | | | 1 | | 15 |
| 3 | 12B | 25 | 6 | | | | 2 | | 15 |
| 4 | 10A | 25 | 4 | | | | 3 | | 15 |
| 5 | 12A | 25 | 2 | | | | 4 | | 15 |
| 6 | 21 | | 3 | | 10 | | 1.9 | | 3 |
| 7 | 19 | | 1.4 | | 10 | | 2.7 | | 3 |
| 8 | 20 | | 0 | | 10 | | 3.4 | | 3 |
| 9 | 22A (L) | 25 | | 10 | | | 0 | | 15 |
| 10 | 22B | 25 | | 2 | | | 4 | | 15 |
| 11 | 23 | 25 | | | | 4 | | 3 | 15 |

In the series of experiments, on going from entry 1 to 5, from entry 6 to 8 and from entry 9 to 10, in the polymerization reaction mixture, the content of di-vinylic branching monomer increases and whereas the content of mono-vinylic co-monomers decreases. Preparation of HBPs with tertiary amine groups requires less of the C12-thiol chain transfer agent and less of co-monomers (Entries 6 to 8). Entries 1 and 9 represent the linear and non-branched reference copolymers.

TABLE 2
Compositional data of the isolated HBPs

| Example | | Molar ratio of the monomeric units in the HBP | | | | | | | |
|---|---|---|---|---|---|---|---|---|---|
| Entry | HBP | 4-VP | HEMA | MMA | DAMA | IAA | di-MA | MBAA | C12-thiol |
| 1 | 10B (L) | 10 | 6.7 | | | | 0.0 | | 2.1 |
| 2 | 8C | 10 | 4.5 | | | | 0.4 | | 1.9 |
| 3 | 12B | 10 | 4.6 | | | | 1.5 | | 2.2 |
| 4 | 10A | 10 | 2.3 | | | | 1.8 | | 3.5 |
| 5 | 12A | 10 | 1.4 | | | | 2.7 | | 2.9 |
| 6 | 21 | | 3 | | 10 | | 1.9 | | 2.0 |
| 7 | 19 | | 1.4 | | 10 | | 2.7 | | 1.1 |
| 8 | 20 | | 0 | | 10 | | 3.4 | | 5.5 |
| 9 | 22A (L) | 10 | | 4.8 | | | 0 | | 1.4 |
| 10 | 22B | 10 | | 0.7 | | | 1.3 | | 3.2 |
| 11 | 23 | 10 | | | | 1.8 | | 1.4 | 3.4 |

Note:
The ratios HEMA/di-MA (for Entries 1 to 8) and MMA/di-MA (for Entries 9 and 10) cannot be derived from the ¹H NMR-data. The represented data reflect the ratio that is used in the reaction mixture.

### EXAMPLE 13

### Properties of the HBPs

Some molecular and material properties of the synthesized HBPs have been listed in Table 3. All prepared HBPs have contents of pyridine or amine groups that are in a similar range, varying somewhat from 3 to 6 mmol/g. The molecular weights of the HBPs, as well as the polydispersity index (PDI) seem to correlate with the used amount of branching monomer (Entries 1 to 5, 6 to 8, and 9 to 10). This is especially apparent for the tertiary amine containing HBP-copolymers (Entries 6 to 8), possibly because in these cases the materials have been prepared in high-yielding reactions that may not suffer from side reactions (i.e. no significant thio-ether formation). The glass transition temperature (Tg) of the tertiary amine containing HBPs (Entries 6 to 8) is lower than those for the pyridine containing HBPs (Entries 2 to 5, and Entry 10), while the acrylamide based HBP (Entry 11) exhibits the highest Tg-value.

TABLE 3
Compiled properties of the prepared HBPs.

| | | pyridine or | | | | |
|---|---|---|---|---|---|---|
| Example | | amine content | Mn | Mw | PDI | Tg |
| Entry | HBP | mmol/g | kg/mol | kg/mol | (—) | ° C. |
| 1 | 10B (L) | 4.2/4.0* | 0.2 | 0.3 | 1.7 | 39 |
| 2 | 8C | 4.7/4.5* | 1.1 | 4.2 | 3.7 | 57 |
| 3 | 12B | 4.1/4.0* | 1.8 | 3.8 | 2.1 | 66 |
| 4 | 10A | 4.1/3.9* | 1.1 | 3.6 | 3.4 | 30 |
| 5 | 12A | 4.1/4.0* | 3.1 | 7.5 | 2.4 | 71 |
| 6 | 21 | 3.6/3.0* | 3.5 | 13.4 | 3.9 | 1 |
| 7 | 19 | 3.9/2.8* | 4.7 | 17.1 | 3.7 | 9 |
| 8 | 20 | 2.9/2.8* | 6.8 | 71.9 | 10.6 | n.o. |
| 9 | 22A (L) | 5.5/5.3* | 0.7 | 1.5 | 2.1 | 41 |
| 10 | 22B | 4.9/4.1* | 2.8 | 7.4 | 2.7 | 54 |
| 11 | 23 | 4.7 | 1.3 | 3.9 | 3.0 | 134 |

Pyridine or amine contents were derived from ¹H NMR spectral data, and were also recorded by elemental analyses (the data indicated with an *); Mn = number average molecular weight, Mw = weight average molecular weight, PDI = Mw/Mn = polydispersity index, all three determined by GPC; Tg = glass transition temperature as determined by DSC; n.o. = not observed, but the material is somewhat sticky, so the Tg should be ca. 0 to 10° C.

### EXAMPLE 14

### The Solubility of the HBPs

The solution properties of the HBPs are exemplified in experiments that compare the HBP 10A with the reference linear copolymer 10B. Both are well soluble in ethanol up to concentrations of at least 1 g material per ml of solvent, but the viscosity of a solution of the linear copolymer 10B in ethanol is higher than that of a 10A solution in ethanol at the same concentration by weight. The HBP 10A is soluble in a variety of solvents other than alcohols, such as chloroform and THF, whereas the linear copolymer 10B is not, or has only very limited solubility in these solvents. The solubility experiments indicate that HBPs provide for a broader range of processing conditions (choice of solvent, high concentrations) can be used and tested in the production of crosslinked HBP with ion exchange groups. The HBPs that possess tertiary amine groups 19, 20 and 21 are well-soluble in ethanol, while these materials are also properly soluble in chloroform, methanol, THF and DMF. The acrylamide based HBP 23 displays similar solubility as HBPs 19, 20 and 21.

### EXAMPLE 15

### Crosslinking

HBP 12A (0.1 g, 0.41 mmol pyridine groups) was dissolved in 0.1 ml ethanol under stirring for at least 0.5 h to yield a yellow, homogeneous and clear solution. Subsequently, 17 microliter (0.10 mmol, 0.25 molar equivalent, thus 0.50 molar equivalents of iodo reactive groups) of 1,6-di-iodohexane was added. The mixture was stirred for 15 min., and then a droplet of the homogeneous mixture was placed on a glass slide and the solvent was allowed to evaporate for 1 h. After leaving the film at room temperature for two days, FT-IR spectroscopy indicated a ca. 50% conversion of the pyridine reactive groups into pyridinium anion exchange groups by quaternization with the iodo reactive groups, as the intensities of the peaks at ca. 1639 cm⁻¹ (indicative of pyridinium groups) and at ca. 1599 cm⁻¹ (indicative of pyridine groups) were about equal. In the starting HBP 12A only the resonance at ca. 1599 cm⁻¹ is visible (strong resonance signal). Because only 0.50 molar equivalents of iodo groups were applied, this indicates a high, almost complete crosslinking. Assuming full conversion of the iodo groups in the crosslinking, a density of approximately 1.5 mmol pyridinium anion exchange groups per gram of dry crosslinked HBP material can be calculated. The quaternization reaction may be achieved more quickly by heating of the dried-in droplet at 50° C. for 8 hrs. After the crosslinking, the quaternization reaction, the droplet had transformed into a tough, non-sticky material. FT-IR (ATR): ν (cm−1)=3416, 2925, 2854, 1718, 1639, 1599, 1559, 1515, 1468, 1416, 1383, 1218, 1169, 1070, 1031, 994, 967, 822, 757.

### EXAMPLE 16

### Preparation of a Sheet of Crosslinked HBP with Anion Exchange Groups

A small bottle (volume ca. 40 ml) was filled with ca. 2 to 5 ml of ethanol and 1.0 to 2.0 g of HBP copolymer (or reference linear copolymer) was added, divided over 3 to 5 approximately equal portions. A magnetic stirrer was added to the bottle that was sealed with a lid, and the solution was stirred gently for at least 12 hours until a homogeneous and clear solution was obtained, indicating that the HBP had fully dissolved. Then 0.5 to 0.7 g of the 1,6-diiodohexane crosslinker was added to the HBP solution and the solution was again gently stirred, now for 6 minutes. The solution thus had a solid content of about 35% to 45% by weight. A sample of 1.5 ml was taken from the bottle with a syringe and was coated onto a polyethylene support (Solupor 7P03A, Lydall Solutech B.V.), using a Zehntner™ ZAA2300 film applicator. The coated film was left to cure for at least a full day, which resulted in a sheet with a thickness in the range of circa 40 micrometer. The following amounts were used for the preparation of sheets of the respective crosslinked linear copolymer with ion exchange groups and crosslinked HBP with ion exchange group; ethanol (g), linear copolymer or HBP (g), and 1,6-diiodohexane crosslinker (g) for linear 10B: 4.82, 1.92, 0.63 grams and 2.40, 1.00, 0.74 grams; for HBP 8C: 4.91, 1.88, 0.60 grams and 2.41, 1.00, 0.72 grams; for HBP 12B: 4.92, 1.95, 0.59 grams and 2.41, 1.01, 0.71 grams; for HBP 10A: 4.86, 1.83, 0.68 and 2.40, 1.09, 0.71 grams; for HBP 12A: 4.85, 1.96, 0.55 grams and 2.40, 1.04, 0.74 grams. Thus, for every crosslinked HBP (or linear copolymer) with ion exchange groups, two sheets were prepared, one with an IEC density of ca. 1.5 mmol/g and one with an IEC density of ca. 2.5 mmol/g (in mmol pyridinium groups per gram of dry crosslinked material, assuming a maximum conversion of the reactive groups).

### EXAMPLE 17

### The Performance of the Sheets of the Crosslinked HBP with Ion Exchange Groups

Anion exchange membranes comprising sheets of crosslinked linear copolymers and crosslinked HBP copolymers with pyridinium groups (i.e. ion exchange groups), as prepared in Example 16 were tested for their selectivity, resistance and thickness; see Table 4 for the results. Membrane characterization was done according to standard methods, which is described in more detail in Dlugolecki, P. et al Journal of Membrane Science 319 (2008) 214-222

TABLE 4
Properties of anion exchange membranes comprising
crosslinked linear copolymers or crosslinked HBP-
copolymers, both with pyridinium exchange groups.

| | HBP- | DB of HBP- | IEC | Permselectivity | Resistance |
|---|---|---|---|---|---|
| Entry | copolymer | copolymer | (meq/g) | (%) | (Ω · cm²) |
| 1 | 10B (L) | zero | 1.5 | 85.2 | 2.35 |
| 2 | 8C | lowest | 1.4 | 88.0 | 3.31 |
| 3 | 12B | medium | 1.4 | 90.7 | 4.64 |
| 4 | 10A | high | 1.6 | 90.3 | 2.73 |
| 5 | 12A | highest | 1.3 | 92.1 | 6.03 |
| 6 | 10B (L) | zero | 2.5 | 88.6 | 1.06 |
| 7 | 8C | lowest | 2.5 | 90.4 | n.d. |
| 8 | 12B | medium | 2.4 | 90.9 | 2.05 |
| 9 | 10A | high | 2.3 | 91.7 | 1.25 |
| 10 | 12A | highest | 2.5 | 92.3 | 3.02 |

* The thickness of all membrane films was circa 40 microns; n.d. = not determined.

The above data indicate that HBP copolymers are more suitable for preparation of ion exchange membranes than linear copolymers, as higher permselectivities are attained. Electrical resistances for all materials are relatively low.

### EXAMPLE 18

### HBP 35B

3-(Dimethylamino)propyl methacrylamide (DAPMA, 15.19 g, 88.3 mmol), N-isopropyl acrylamide (IAA, 3.02 g, 26.4 mmol), N,N′-methylene bisacrylamide (MBAA, 2.78 g, 17.7 mmol), dodecane thiol (6.5 ml, 27.0 mmol) and AIBN (252 mg, 1.51 mmol) were mixed in ethanol (50 ml) in a 2-neck 100 ml round-bottom flask. The white suspension was purged with argon for 1 h under stirring. A reflux condenser was fitted and the reaction mixture was heated at an oil bath temperature of 73° C. giving a clear solution. The mixture was stirred under argon for another 23 h after which a hazy, viscous mixture was obtained. Insoluble components were removed by filtering over a glass filter. The solvent was removed in vacuo to yield a sticky colorless residue that was then mixed with acetonitrile (150 ml). Heating to reflux under stirring gave a clear solution, while cooling to room temperature induced precipitation of a beige, viscous material. The solution was decanted off and the residue was washed with acetonitrile (50 ml), with the acetonitrile solution again removed by decantation. The residue was mixed with ethanol (100 ml) in a round bottom flask by swirling to yield a white suspension. Filtration over a folded paper filter gave a colorless, clear filtrate that was concentrated in vacuo using a rotary evaporator. Drying of the residue in a vacuum oven (using KOH as drying agent) yielded a sticky, white residue (11.05 g, 42%). This is HBP 35B. ¹H—NMR (CDCl₃): δ=7.78 (N—H, very broad peak), 4.60 (CH₂ bisacrylamide, bp), 3.95 (CH N-isopropylacrylamide, bp), 3.12 (CH₂ methacrylamide, bp), 2.5-1.0 (multiple bp), 0.91 ppm (alkyl tail CH₃); FT-IR (ATR): ν (cm⁻¹)=3298, 3071, 2925, 2855, 2820, 2778, 1639, 1526, 1461, 1384, 1293, 1261, 1231, 1197, 1159, 1100, 1062, 1039, 993, 913, 843, 765, 729. Number of pyridine groups as derived from ¹H NMR data: 3.3 mol/kg HBP. Tg=73° C.

### EXAMPLE 19

### HBP 39

3-(Dimethylamino)propyl methacrylamide (DAPMA, 17.22 g, 100 mmol), N-isopropyl acrylamide (IAA, 2.60 g, 22.7 mmol), N,N′-methylene bisacrylamide (MBAA, 1.56 g, 9.89 mmol), dodecane thiol (7.4 ml, 30.1 mmol) and AIBN (252 mg, 1.51 mmol) were mixed in ethanol (50 ml) in a 3-neck 100 ml round-bottom flask. The white suspension was purged with argon for 1 h under stirring. A reflux condenser was fitted and the viscous reaction mixture was heated at an oil bath temperature of 85° C. giving a clear solution. The mixture was stirred under argon for another 17 h after which a white suspension was obtained. Solvents were removed in vacuo and the residue was mixed with petroleum ether (50 ml) and refluxed for 30 min. The mixture was allowed to cool to room temperature and was then centrifuged (20 min., 4000 rpm) to give a phase-separated mixture. The turbid supernatant was decanted and the sticky residue was mixed with petroleum ether (25 ml), centrifuged once more (20 min., 4000 rpm) and decanted to give a sticky, beige, viscous substance. This solid was again mixed with petroleum ether (100 ml) and refluxed for 2 hours to give a phase separated mixture of polymer and solvent. Decanting the solvent while still hot gave a residue that was dried in vacuo and that was then mixed with ethanol (200 ml). The obtained mixture was refluxed for several minutes and was allowed to cool to room temperature (overnight). A white precipitate had formed, and the suspension was filtered over a folded filter paper. The filtrate was concentrated in vacuo. The obtained residue was mixed with petroleum ether (100 ml), this mixture was refluxed for 30 min and was then allowed to cool to room temperature. The turbid supernatant was decanted and the residue was dried in a vacuum oven at 65° C. to give HBP 39 as a sticky solid (11.6 g, 41%). ¹H—NMR (CDCl₃): δ=7.65 (N—H, very broad peak), 4.62 (CH₂ bisacrylamide, bp), 3.95 (CH N-isopropylacrylamide, bp), 3.26 (CH₂ methacrylamide, bp), 2.5-1.0 (multiple bp), 0.91 ppm (alkyl tail CH₃); FT-IR (ATR): ν (cm⁻¹)=3312, 2927, 2856, 2818, 2771, 1640, 1519, 1460, 1383, 1342, 1293, 1261, 1242, 1197, 1158, 1099, 1061, 1039, 993, 969, 844, 766. Number of pyridine groups as derived from ¹H NMR data: 4.5 mol/kg. HBP. Tg=61° C.

The above two examples 18 and 19 include extensive work-up procedures. Effective removal of the dithioether side product that is formed by the reaction of MBAA with two equivalents of dodecane may alternatively be achieved by simply diluting the reaction mixture with ethanol followed by filtration and concentration of the filtrate; the dithioether by-product does not dissolve very well in ethanol.

### COMPARATIVE EXAMPLE 20

### Linear Copolymer 49

3-(Dimethylamino)propyl methacrylamide (DAPMA, 19.82 g, 0.115 mmol), N-(2-hydroxyethyl) acrylamide (HEAA, 3.75 g, 31.6 mmol), dodecane thiol (2.85 ml, 13.9 mmol) and AIBN (252 mg, 1.51 mmol) were mixed in ethanol (50 ml) in a 2-neck 100 ml round-bottom flask. The mixture was purged with argon for 1 h under stirring. A reflux condenser was fitted and the viscous reaction mixture was heated at an oil bath temperature of 72° C. giving a clear solution. The mixture was stirred under argon for another 16 h and was subsequently concentrated in vacuo. The residue was mixed with petroleum ether (100 ml) and the solution was refluxed for 1 h. The mixture was allowed to cool to room temperature followed by decanting of the supernatant. The residue was treated with petroleum ether in this manner two more times. Drying (vacuum oven, 60° C.) gave the glassy, sticky copolymer 49. Yield: 24.1 g (93%). ¹H—NMR (CDCl₃): δ=7.8 (N—H, very broad peak), 3.65 (CH₂ hydroxyethyl, bp), 3.26 (CH₂ (meth)acrylamide, bp), 2.5-1.0 (multiple bp), 0.9 ppm (alkyl tail CH₃); FT-IR (ATR): ν (cm⁻¹)=3323, 2926, 2858, 2820, 2776, 1634, 1525, 1462, 1383, 1292, 1260, 1229, 1199, 1159, 1099, 1061, 1039, 993, 968, 843, 765. Number of pyridine groups as derived from ¹H NMR data: 4.6 mol/kg HBP.

### COMPARATIVE EXAMPLE 21

### Linear Copolymer 50

3-(Dimethylamino)propyl methacrylamide (DAPMA, 19.85 g, 0.115 mmol), N-isopropyl acrylamide (IAA, 4.07 g, 34.9 mmol), dodecane thiol (2.85 ml, 13.8 mmol) and AIBN (252 mg, 1.51 mmol) were mixed in ethanol (50 ml) in a 2-neck 100 ml round-bottom flask. The mixture was purged with argon for 1 h under stirring. A reflux condenser was fitted and the viscous reaction mixture was heated at an oil bath temperature of 72° C. giving a clear solution. The mixture was stirred under argon for another 17 h and was subsequently concentrated in vacuo. The residue was mixed with petroleum ether (100 ml) and refluxed for 1h. This mixture was allowed to cool to room temperature after which the supernatant was decanted. The residue was treated with petroleum ether in this manner one more time. Drying (vacuum oven, 60° C.) yielded the glassy, sticky solid 50. Yield: 21.1 g (81%). ¹H—NMR (CDCl₃): δ=7.6 (N—H, very broad peak), 3.9 (CH isopropyl, bp), 3.22 (CH₂ methacrylamide, bp), 2.5-1.0 (multiple bp), 0.9 ppm (alkyl tail CH₃); FT-IR (ATR): ν (cm⁻¹)=3332, 2927, 2858, 2817, 2774, 1634, 1520, 1460, 1384, 1292, 1261, 1230, 1198, 1158, 1130, 1099, 1061, 1039, 993, 968, 843, 765. Number of pyridine groups as derived from ¹H NMR data: 4.7 mol/kg HBP.

### EXAMPLE 22

### Preparation of Membrane Films of HBP 35B, HBP 39, 49 and 50

HBP 35B and HBP 39 are polyamides with pendant tertiary amine groups, while copolymers 49 and 50 may be viewed as linear counterparts of these HBPs. The 4 materials have been crosslinked with 1,10-dibromodecane to prepare anion exchange membrane films with ammonium groups. Accordingly, the appropriate amount of copolymer material was dissolved in ethanol at a concentration of 1 gram copolymer per 2.5 mL of ethanol. To the clear solution was added 0.45-0.50 mol-equivalent of 1,10-dibromodecane (0.9-1.0 molequivalent of bromides), and the mixture was stirred. From the obtained clear solution a film was cast, and the prepared film was immediately heated to 40° C. After 5 hours, the temperature was increased to 60° C., which temperature was maintained for ca. 30 hours to further cure the film. The membrane solution was cast on a Solupor support layer. The casting was done with a Zehnter automatic film applicator (ZAA 2300) and a Zehnter universal applicator (ZUA 2000). The casting thickness was set at 250 μm. After drying the thickness of the membrane was approximately 125 μm.

### EXAMPLE 23

### Anion Exchange Membrane Performances HBP 35B, HBP 39, 49 and 50

The anion exchange membrane films as prepared in Example 22 were tested for their selectivity and resistance. See Table 5 for the results. Membrane characterization was done according to standard methods, which is described in more detail in Dlugolecki, P. et al Journal of Membrane Science 319 (2008) 214-222.

TABLE 5
Properties of anion exchange membranes comprising crosslinked
linear co-polyamides or crosslinked HBP-co-polyamides,
both with ammonium exchange groups.

| | HBP- | DB of HBP- | Permselectivity | Resistance |
|---|---|---|---|---|
| Entry | copolymer | copolymer | (%) | (Ω · cm²) |
| 1 | 35B | higher | 95.0 | 2.06 |
| 2 | 39 | lower | 95.4 | 1.67 |
| 3 | 49 (L) | zero | 89.2 | 1.38 |
| 4 | 50 (L) | zero | 91.0 | 1.59 |

The above data indicate that the HBP co-polyamides are more suitable for preparation of ion exchange membranes than linear co-polyamides, as higher permselectivities are attained. Electrial resistances for all materials are relatively low

### EXAMPLE 24

### Preparation of an Anion Exchange Membrane from the Unpurified HBP 40

2-(Dimethylamino)ethyl methacrylate (DAMA, 10.85 g, 67.6 mmol), 2-hydroxyethyl methacrylate (HEMA, 1.18 ml, 8.80 mmol), 1,4-butanediol dimethacrylate (di-MA, 4.25 ml, 17.8 mmol), dodecane thiol (5.0 ml, 20.3 mmol) and AIBN (190 mg, 1.13 mmol) were dissolved in ethanol (38 ml) in a 3-neck 100 ml round-bottom flask. The colorless, clear solution was purged with argon for 1 h under stirring. A reflux condenser was fitted and the reaction mixture was heated at an oil bath temperature of 73° C. under argon and stirring for 17.5 h. The solvent was evaporated using a rotary evaporator. Drying in a vacuum oven (KOH as drying agent) gave the sticky, orange residue HBP 40 (21.5 g, 100%). ¹H—NMR (CDCl₃): δ=4.07 (ester, bp), 3.81 (alcohol, bp), 2.5-0.6 (multiple bp), 1.25 (alkyl tail CH₂), 0.88 ppm (alkyl tail CH₃); FT-IR (ATR): ν (cm⁻¹)=2925, 2854, 2821, 2770, 1725, 1456, 1386, 1269, 1236, 1147, 1099, 1062, 1040, 1018, 964, 851, 779, 750. Number of amine groups as derived from ¹H NMR data: 3.3 mol/kg HBP.

This crude, unpurified HBP 40 was crosslinked in a film sheet by using 1,10-dibromodecane as a crosslinker. The method for film preparation as described in Example 22 was used. Testing of the membrane characteristics gave a high permselectivity of 93.9% and a low resistance of 1.23 (Ω·cm²).

Finally, in a separate experiment, the crosslinked film that was prepared from the crude HBP 40 was washed by a two-day exposure to ethanol. Removal of non-crosslinked compounds was confirmed by ¹H—NMR examination of the concentrate of the ethanol solution. Weight loss of the film after washing was less than 1 w/w %. Repeated washing of the membrane film, even with chloroform, did not show any further removal of non-crosslinked material, proving the success of the simple one-step ethanol washing step.

### EXAMPLE 25

### Performance of a Flow Through Capacitor (FTC) System Based on Use of a Crosslinked HBP Membrane Material

Material HBP 10A was prepared on a larger scale leading to a material with the following composition: molar ratios 4-VP: HEMA:di-MA:thiol=10:2.6:2.0:2.3. A pyridine content of 4.3 mmol/g was recorded for this material. PDI=6.7 and Mₙ=1.2 kg/mol.

A crosslinked HBP membrane film with ion exchange groups was prepared from this material. Accordingly, a bottle (volume ca. 500 ml) was filled with 100 ml of ethanol and 100.5 g of the HBP that is described above was added. The solution was gently stirred by a magnetic stirrer for at least 12 hours until a homogeneous and clear solution was obtained, indicating that the HBP had fully dissolved. To 50 g of the HBP solution 49.8 g of 1,6-diiodohexane crosslinker was added and the solution was again gently stirred for 6 minutes. Note that the molar ratio between pyridine groups from the HBP and the iodo groups from the crosslinker is ca. 1:2, so that the crosslinking density in the membrane film will be reduced, while the charge density will remain as high as feasible. The solution containing the HBP and crosslinker was taken from the bottle with a syringe and was coated onto a polyethylene support (Solupor 7P03A, Lydall Solutech B.V.) using Zehntner™ ZAA2300 film applicator. The coated film was cured for at least 48 hours at room temperature, which resulted in a crosslinked HBP film with a thickness of circa 50 micrometer. The crosslinked HBP film with ion exchange groups was cut into 20 pieces of 16.5 cm×16.5 cm, and these film pieces were used in a FTC system as anion exchange membranes; 20 cell pairs were used in this FTC system. The permselectivity of several crosslinked HBP samples was higher than 91% (permselectity tests have been described in more detail in Dlugolecki, P. et al Journal of Membrane Science 319 (2008) 214-222). In the same FTC system commercially available membrane Neosepta CMX (Astom Corporation) was used as the cation exchange membrane. A reference system was built, where Neosepta AMX was used as the anion exchange membrane and Neosepta CMX was used as the cation exchange membrane. The flow rate was set to 2 l/min/m² of cell area. The feed solution was flowing through 115 μm thick woven material, that served to separate the anion exchange membrane from the cation exchange membrane. Tap water with NaCl salt was used as feed water, where the conductivity of this solution was 1.5 mS/cm. All experiments were performed at room temperature.

TABLE 6
The performance of FTC systems, either applying Neosepta
AMX (ex Astom Corporation) or applying the crosslinked
HBP as anion ion exchange membrane.

| | Average deioniza- | Maximum | Average |
|---|---|---|---|
| | tion rate | removal | removal |
| FTC system | (g/m²/min) | (%) | (%) |
| Neosepta AMX | 1.36 | 98.4 | 88.2 |
| Crosslinked HBP AEM | 1.29 | 94.8 | 84.0 |

The results above show that an initial test using HBPs in FTCs gives similar results when compared with a commercially available and optimized membrane material.

### EXAMPLE 26

Example 15 is repeated, instead of using only the 1,6-diiodohexane crosslinker, 0.08 mmol of 1,6-diiodohexane (crosslinker) and 0.16 mmol of 1-iodohexane (group activator) were used in the crosslinking step instead. FT-IR spectroscopy is performed on the crosslinked membrane.

1. An apparatus to remove ions, the apparatus comprising:
a housing;
an inlet to let water into the housing;
an outlet to let water out of the housing;
a first electrode and a second electrode in the housing;
a spacer between the first and second electrodes to allow water to flow in between the first and second electrodes; and
an ion exchange membrane between the first and/or second electrode and the spacer,
wherein the membrane comprises a crosslinked hyperbranched (co)polymer with an ion exchange group.

2. A method for preparing a crosslinked hyperbranched (co)polymer with ion exchange groups, the method comprising:
crosslinking a hyperbranched (co)polymer with a crosslinker,
wherein the crosslinker and/or hyperbranched (co)polymer comprises an ion exchange group and/or wherein, during the crosslinking, an ion exchange group is formed.

3. The method according to claim 2, wherein crosslinking of the hyperbranched (co)polymer with the crosslinker is performed directly on a support layer or an electrode.

4. The method according to claim 2, wherein crosslinking of the hyperbranched (co)polymer with the crosslinker is performed first in a reactor and the crosslinked hyperbranched (co)polymer is subsequently transferred to a support layer or an electrode where the reaction is completed.

5. (canceled)

6. The method according to claim 2, wherein the ion exchange group is formed during the crosslinking.

7. The method according to claim 6, wherein the hyperbranched (co)polymer and crosslinker comprise reactive groups that are capable of reacting with each other to form a covalent bond and the ion exchange group.

8. The method according to claim 6, wherein the ion exchange group is an anion exchange group.

9. The method according to claim 8, wherein the reactive group of the hyperbranched (co)polymer is a tertiary amine, a pyridine, a guanidine and/or a phosphine group and the reactive group of the crosslinker is a halide, tosylate, mesylate or triflate group, or wherein the reactive group of the hyperbranched (co)polymer is a halide, tosylate, mesylate or triflate and the reactive group of the crosslinker is a tertiary amine, a pyridine, a guanidine and/or a phosphine group.

10. The method according to claim 6, wherein the ion exchange group is a cation exchange group.

11. The method according to claim 10, wherein the reactive group of the hyperbranched (co)polymer is a primary or secondary amine group, and the reactive group of the crosslinker is a cyclic anhydride, or wherein the reactive group of the hyperbranched (co)polymer is a cyclic anhydride, and the reactive group of the crosslinker is a primary or secondary amine group.

12. The method according to claim 2, wherein the crosslinker and/or hyperbranched (co)polymer comprises a hydrophilic group and/or hydrophobic group.

13. The method according to claim 2, further comprising before, during and/or after the crosslinking, reacting a group activator with the hyperbranched (co)polymer and/or crosslinked hyperbranched (co)polymer with an ion exchange group.

14. The method according to claim 2, wherein the hyperbranched (co)polymer is prepared by:
providing one or more branching monomer(s),
reacting a branching monomer and an initiator to form the hyperbranched (co)polymer.

15. The method according to claim 14, wherein the reacting comprises an addition polymerization.

16. The method according to claim 14, further comprising reacting a co-monomer and a chain transfer agent with the branching monomer and initiator, wherein the molar ratio of co-monomer:branching monomer:chain transfer agent is about 5-80:0.5-20:1-30.

17. The method according to claim 14, further comprising reacting a co-monomer with the branching monomer and the initiator, wherein the molar ratio of co-monomer:branching monomer is lower than 100:1.

18. The method according to claim 14, further comprising reacting a co-monomer with the branching monomer and the initiator, wherein the branching monomer comprises at least two vinyl groups, the co-monomer comprises vinyl, and the vinyl groups are suitable for addition polymerization.

19. The method according to claim 18, wherein the branching monomer is a di(meth)acrylate and/or a bisacrylamide.

20. The method according to claim 19, wherein the branching monomer is 1,4-butanediol dimethacrylate and/or methylene bisacrylamide.

21. The method according to claim 14, further comprising reacting a co-monomer with the branching monomer and the initiator, wherein the co-monomer is a vinyl-aryl, a (meth)acrylate, and/or a (meth)acrylamide.

22. The method according to claim 21, wherein the co-monomer is 4-vinylpyridine, 2-hydroxyethyl-methacrylate, methylmethacrylate, (dimethylamino)ethyl methacrylate, 3-(dimethylamino)propyl methacrylamide, N-(2-hydroxyethyl)-acrylamide and/or N-isopropylacrylamide.

23. The method according to claim 14, wherein the chain transfer agent is a thiol.

24. A material comprising a crosslinked hyperbranched (co)polymer with an ion exchange group obtainable or obtained by the method of claim 2.

25. The material according to claim 24, wherein it is in the form of a sheet.

26. The material according to claim 24, wherein it is in the form of an ion exchange membrane.

27. The material according to claim 26, wherein the thickness of the membrane is less than 200 micrometers.

28. An apparatus to remove ions wherein the apparatus comprises an ion exchange membrane according to claim 26.

29. Use of a crosslinked hyperbranched (co)polymer with an ion exchange group or a crosslinked hyperbranched (co)polymer with an ion exchange group on an electrode according to claim 2, of an ion exchange membrane having a crosslinked hyperbranched (co)polymer with an ion exchange group, or of an apparatus having a crosslinked hyperbranched (co)polymer with an ion exchange group, for the removal of ions from water.
